(19) United States
(12) Patent Application Publication
(10) Pub. No.: US 2026/0006346 A1
(43) Pub. Date: Jan. 1, 2026

(54) IMAGE SENSOR

(71) Applicant: SAMSUNG ELECTRONICS CO., LTD., SUWON-SI (KR)

(72) Inventors: Masato FUJITA, Suwon-si (KR); Seung Ki JUNG, Suwon-si (KR); Seung Ki BAEK, Suwon-si (KR); Doo Sik SEOL, Suwon-si (KR); Sung Min AN, Suwon-si (KR); Kyung Duck LEE, Suwon-si (KR); Tae Sub JUNG, Suwon-si (KR)

(21) Appl. No.: 19/187,451

(22) Filed: Apr. 23, 2025

(30) Foreign Application Priority Data
Jul. 1, 2024 (KR) 10-2024-0086007

(51) Int. Cl. H04N 25/51; H04N 25/77

(52) U.S. Cl. CPC H04N 25/51; H04N 25/77

(57) ABSTRACT

An image sensor includes a substrate with a first pixel group and a second pixel group disposed thereon. The first pixel group includes first and second pixels adjacent in a first direction, and third and fourth pixels adjacent to the first and second pixels in a second direction. The second pixel group, located adjacent to the first pixel group in the second direction, includes fifth and sixth pixels. A first floating diffusion region is electrically connected to the first to fourth pixels, and a second floating diffusion region is electrically connected to the fifth and sixth pixels. Each pixel includes photoelectric conversion elements and transfer transistors connecting the elements to their respective floating diffusion regions. The second pixel group includes a first capacitor, while the first pixel group includes a first reset transistor that connects the first capacitor to the first floating diffusion region, controlled by a first control signal.

### CROSS-REFERENCE TO RELATED APPLICATION

This patent application claims priority under 35 U.S.C. 119 to Korean Patent Application No. 10-2024-0086007 filed on Jul. 1, 2024 in the Korean Intellectual Property Office, the disclosure of which is incorporated by reference in its entirety herein.

### 1. TECHNICAL FIELD

The present disclosure is directed to an image sensor.

### 2. DISCUSSION OF RELATED ART

An image sensor is a semiconductor device that receives light and converts the received light into an electrical signal to capture images. The image sensor may be a component in digital cameras, smartphones and medical image devices.

The image sensor may include a pixel array having a plurality of pixels and a logic circuit for driving the pixel array to generate an image. Each of the pixels may include a photodiode and a pixel circuit for converting a charge generated in the photodiode into an electrical signal.

The conversion gain of an image sensor refers to the amount of output signal (in volts or electrons) generated per unit of input light signal (in photons) received by a pixel. It quantifies the sensor's ability to convert captured light into an electronic signal and is typically measured in units of microvolts per electron (μV/e⁻) or electrons per photon.

Reducing the conversion gain of an image sensor can be desirable in certain scenarios to achieve specific performance characteristics, especially when dealing with high dynamic range (HDR) imaging or situations where bright-light conditions dominate. Increasing the conversion gain may be desirable in scenarios where enhanced sensitivity and better signal detection are needed, especially in low-light conditions. However, it can be difficult to dynamically adjust the conversion gain to satisfy both bright-light and low-light conditions without compromising performance or increasing design complexity, which can limit the level of integration achievable in the sensor.

### SUMMARY

Aspects of the present invention provide an image sensor having increased performance and an increased degree of integration.

According to an embodiment of the present disclosure, there is provided an image sensor including a substrate, a first pixel group disposed on the substrate, and including a first pixel and a second pixel disposed adjacent to the first pixel in a first direction, a third pixel disposed adjacent to the first pixel in a second direction intersecting the first direction, and a fourth pixel disposed adjacent to the second pixel in the second direction, a second pixel group disposed adjacent to the first pixel group in the second direction that includes a fifth pixel disposed adjacent to the third pixel in the second direction, and a sixth pixel disposed to be adjacent to the fourth pixel in the second direction, a first floating diffusion region electrically connected to the first to fourth pixels and a second floating diffusion region electrically connected to the fifth and sixth pixels. Each of the first to fourth pixels includes a first photoelectric conversion element, a first transfer transistor connected to the first photoelectric conversion element and the first floating diffusion region, a second photoelectric conversion element, and a second transfer transistor connected to the second photoelectric conversion element and the first floating diffusion region. Each of the fifth pixel and the sixth pixel includes a third photoelectric conversion element, a third transfer transistor connected to the third photoelectric conversion element and the second floating diffusion region, a fourth photoelectric conversion element, and a fourth transfer transistor connected to the fourth photoelectric conversion element and the second floating diffusion region. The second pixel group include a first capacitor. The first pixel group includes a first reset transistor that connects the first capacitor to the first floating diffusion region based on a first control signal.

According to an embodiment of the present disclosure, an image sensor includes a substrate, a first pixel group disposed on the substrate, and includes a first pixel and a second pixel disposed adjacent to the first pixel in a first direction, a third pixel disposed adjacent to the first pixel in a second direction intersecting the first direction, and a fourth pixel disposed adjacent to the second pixel in the second direction, a second pixel group disposed adjacent to the first pixel group in the second direction, and includes a fifth pixel disposed adjacent to the third pixel in the second direction, and a sixth pixel disposed adjacent to the fourth pixel in the second direction, a first floating diffusion region electrically connected to the first to fourth pixels and a second floating diffusion region electrically connected to the fifth and sixth pixels. Each of the first to fourth pixels includes a first photoelectric conversion element, a first transfer transistor connected to the first photoelectric conversion element and the first floating diffusion region, a second photoelectric conversion element, and a second transfer transistor connected to the second photoelectric conversion element and the first floating diffusion region, each of the fifth pixel and the sixth pixel includes a third photoelectric conversion element, a third transfer transistor connected to the third photoelectric conversion element and the second floating diffusion region, a fourth photoelectric conversion element, and a fourth transfer transistor connected to the fourth photoelectric conversion element and the second floating diffusion region. The second pixel group includes first and second capacitors. The first pixel group includes a first reset transistor that connects the first capacitor to the first floating diffusion region based on a first control signal, and a second reset transistor that connects the second capacitor, the first capacitor, and the first floating diffusion region based on a second control signal.

According to an embodiment of the present disclosure, an image sensor includes a substrate, first and second floating diffusion regions disposed in the substrate, a first pixel including first and second photoelectric conversion elements, a first transfer transistor that connects the first photoelectric conversion element and the first floating diffusion region, and a second transfer transistor that connects the second photoelectric conversion element and the first floating diffusion region, a second pixel including third and fourth photoelectric conversion elements, a third transfer transistor that connects the third photoelectric conversion element and the first floating diffusion region, and a fourth transfer transistor that connects the fourth photoelectric conversion element and the first floating diffusion region, a third pixel including fifth and sixth photoelectric conversion elements, a fifth transfer transistor that connects the fifth photoelectric conversion element and the first floating diffusion region, and a sixth transfer transistor that connects the sixth photoelectric conversion element and the first floating diffusion region, a fourth pixel including seventh and eighth photoelectric conversion elements, a seventh transfer transistor that connects the seventh photoelectric conversion element and the first floating diffusion region, and an eighth transfer transistor that connects the eighth photoelectric conversion element and the first floating diffusion region, a fifth pixel which includes ninth and tenth photoelectric conversion element, a ninth transfer transistor that connects the ninth photoelectric conversion element and the second floating diffusion region, and a tenth transfer transistor that connects the tenth photoelectric conversion element and the second floating diffusion region and a sixth pixel which includes eleventh and twelfth photoelectric conversion element, an eleventh transfer transistor that connects the eleventh photoelectric conversion element and the second floating diffusion region, and a twelfth transfer transistor that connects the twelfth photoelectric conversion element and the second floating diffusion region. At least one of the third to sixth pixels includes a first and a second capacitor, a first reset transistor that connects the first capacitor and the first floating diffusion region based on a first control signal, and a second reset transistor that connects the second capacitor, the first capacitor and the first floating diffusion region based on a second control signal.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram showing an image sensor according to an embodiment of the present invention.

FIG. 2 is a simplified diagram showing a pixel array included in the image sensor according to an embodiment of the present invention.

FIG. 3 is a circuit diagram showing a pixel of the image sensor according to an embodiment of the present invention.

FIG. 4 is a diagram showing some pixels included in the image sensor according to an embodiment of the present invention.

FIG. 5 is a cross-sectional view showing a cross section in a I-I′ direction of FIG. 4.

FIG. 6 is a cross-sectional view showing a cross section in a II-II′ direction of FIG. 4.

FIGS. 7 to 13 are cross-sectional views showing a capacitor included in a pixel of an image sensor according to an embodiment.

FIGS. 14 to 18 are diagrams for explaining the operation of an image sensor according to an embodiment.

FIGS. 19 to 21 are diagrams showing some pixels included in the image sensor according to an embodiment of the present invention.

FIG. 22 is a circuit diagram showing a pixel of the image sensor according to an embodiment of the present invention.

FIGS. 23 to 29 are diagrams showing some pixels included in the image sensor according to an embodiment of the present invention.

FIGS. 30 to 32 are diagrams showing some pixels included in the image sensor according to an embodiment of the present invention.

FIG. 33 is a circuit diagram showing a pixel of the image sensor according to an embodiment of the present invention.

FIG. 34 is a diagram showing some pixels included in the image sensor according to an embodiment of the present invention.

FIGS. 35 to 37 are cross-sectional views showing a shape of the capacitor included in the pixel of the image sensor according to an embodiment.

### DETAILED DESCRIPTION

Hereinafter, embodiments of the present invention will be described in detail referring to the attached drawings. Same reference numerals are used for the same components in the drawings, and the repeated explanations thereof will not be provided.

Embodiments of the inventive concept provide an image sensor that dynamically adjusts conversion gain to optimize performance in both bright-light and low-light conditions without increasing design complexity. This is achieved by controlling the capacitance of the floating diffusion (FD) region using reset transistors and capacitors. In low-light conditions, the reset transistors are turned off, minimizing FD capacitance and increasing conversion gain to enhance sensitivity. In bright-light conditions, the reset transistors are turned on, connecting additional capacitance to the FD region, reducing conversion gain to prevent saturation. Control signals are used to selectively activate these transistors, enabling precise adjustment of capacitance. A modular design, with shared FD regions and strategically placed components may maintain high integration and avoid added complexity, making the sensor efficient and adaptable to varying illumination conditions.

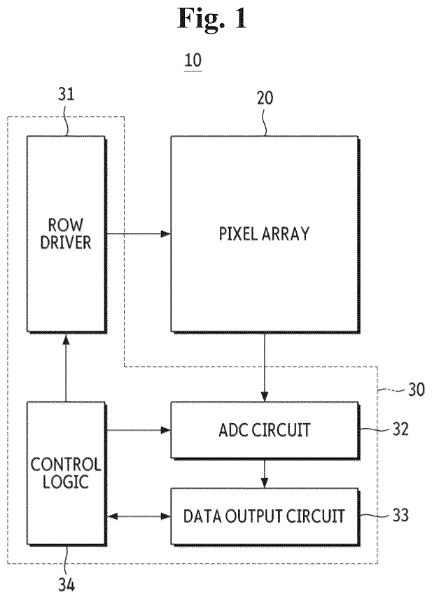

FIG. 1 is a block diagram showing an image sensor according to an embodiment of the present invention.

Referring to FIG. 1, an image sensor 10 may include a pixel array 20 and a peripheral circuit 30. The pixel array 20 may include a plurality of pixels disposed in an array form along a plurality of rows and a plurality of columns. Each of the plurality of pixels may include at least one photoelectric conversion element that generates a charge in response to light and a pixel circuit that generates a voltage signal corresponding to the charge generated by the photoelectric conversion element. The photoelectric conversion element may include a photodiode formed of a semiconductor material, and/or an organic photodiode formed of an organic material.

For example, the pixel circuit may include a floating diffusion region, a transfer transistor, a reset transistor, a drive transistor and a selection transistor. However, the configuration of the pixels may vary depending on the embodiments. For example, each of the pixels may include an organic photodiode having an organic material, or may be implemented as a digital pixel. When the pixels are implemented as digital pixels, each of the pixels may include an analog-to-digital converter for outputting a digital pixel signal.

The peripheral circuit 30 may include circuits for controlling the pixel array 20. For example, the peripheral circuit 30 may include a row driver 31 (e.g., a driver circuit), an analog-to-digital converter (ADC) circuit 32, a data output circuit 33 and control logic 34 (e.g., a logic circuit). The row driver 31 may drive the pixel array 20 on the basis of row lines. For example, the row driver 31 may generate a transfer control signal for controlling a transfer transistor of a pixel circuit, a reset control signal for controlling a reset transistor, a selection control signal for controlling a selection transistor, and the like, and may input them to the pixel array 20 on a row line basis.

The ADC circuit 32 may include a plurality of correlated double samplers and a plurality of counters, and the correlated double samplers may be connected to the pixels through column lines. The correlated double samplers may read voltage signals through the column lines from pixels connected to a row line selected by a row line selection signal of the row driver 31. The analog-to-digital converter included in the A DC circuit 33 may convert the output of the correlated double sampler into a digital pixel signal. For example, a latch or buffer circuit capable of temporarily storing a digital pixel signal and an amplifier circuit may be connected to an output terminal of the analog-to-digital converter. The control logic 34 may include a timing controller for controlling the operation timing of the row driver 31, the CDS circuit 32, and the ADC circuit 33.

Pixels PX disposed at the same position in a horizontal direction among the pixels PX may share the same column line. For example, pixels PX disposed at the same position in a vertical direction may be simultaneously selected by the row driver 31, and output pixel signals through the column lines. In an embodiment, the CDS circuit 32 simultaneously receives voltage signals from the pixels selected by the row driver 31 through the column lines. For example, the CDS circuit 32 may sequentially receive a reset voltage and a pixel voltage from each of the pixels, and the pixel voltage may be a voltage in which the charge generated in each photodiode of the pixel is reflected in the reset voltage.

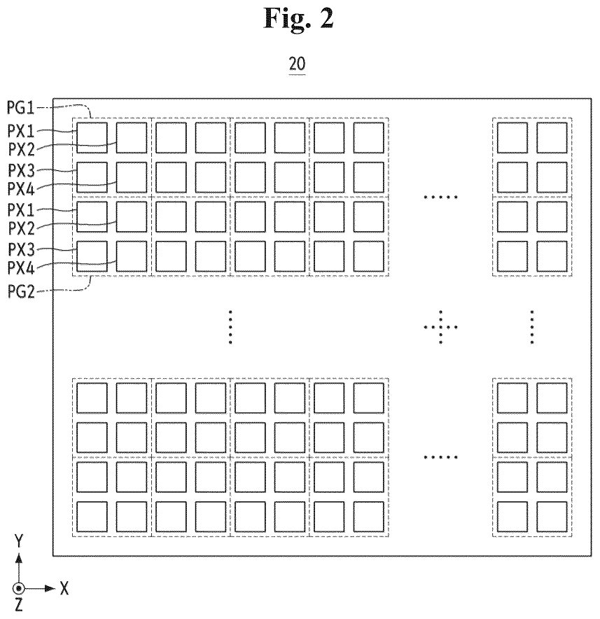

FIG. 2 is a simplified diagram showing a pixel array included in the image sensor according to an embodiment of the present invention.

Referring to FIG. 2, a pixel array 20 according to an embodiment of the present invention includes a plurality of pixel regions arranged along a first direction (X direction) and a second direction (Y direction), and a plurality of pixels may be disposed in the plurality of pixel regions. For example, the plurality of pixel regions and the plurality of pixels may correspond on a one-to-one basis. The plurality of pixels may be configured to output a voltage signal corresponding to the charge generated in response to light, and may be connected to a peripheral circuit by a plurality of row lines extending in the first direction and a plurality of column lines extending in the second direction.

As shown in FIG. 2, in the image sensor according to an embodiment of the present invention, a first pixel PX 1 and a second pixel PX 2 that are adjacent to each other in the first direction (X direction), a third pixel PX 3 adjacent to the first pixel PX 1 in the second direction (Y direction) intersecting the first direction (X direction), and a fourth pixel PX 4 adjacent to the second pixel PX2 in the second direction (Y direction) may be included in a single pixel group. Similarly, a plurality of pixel groups PG may be disposed in the pixel array 20 along the first direction and the second direction. For example, the first pixel group PG1 may include the first pixel PX1 and the second pixel PX2 that are adjacent to each other in the first direction (X direction), the third pixel PX3 adjacent to the first pixel PX1 in the second direction (Y direction), and the fourth pixel PX4 adjacent to the second pixel PX2 in the second direction (Y direction). The second pixel group PG2 is adjacent to the first pixel group PG1 in the second direction (Y direction), and may include the first pixel PX1 and the second pixel PX2 that are adjacent to the third pixel PX3 and the fourth pixel PX4 of the first pixel group PG1 in the second direction (Y direction), the third pixel PX3 adjacent to the first pixel PX1 of the second pixel group PG2 in the second direction (Y direction), and the fourth pixel PX4 adjacent to the second pixel PX2 of the second pixel group PG2 in the second direction (Y direction).

In each of the plurality of pixel groups, the floating diffusion regions of the first pixel PX1 to the fourth pixel PX4 may be connected to each other. Also, a plurality of transistors disposed in the pixel region of the first pixel PX1 and a plurality of transistors disposed in the pixel region of the second pixel PX2 may provide a pixel circuit that converts the charge generated in the photodiode of each of the first pixel PX1 and the second pixel PX2 into a voltage signal. For example, transistors that operate as amplifiers included in the pixel circuit and transistors that operate as switches may be disposed in the first pixel PX1 to the fourth pixel PX4 of each of the first pixel group PG1 and the second pixel group PG2.

By disposing the transistors, which implement a pixel circuit that converts the charge generated in the photodiode included in one pixel group into the voltage signal, in the adjacent pixel groups, it is possible to prevent saturation of the photodiodes of each of the plurality of pixels in a high-illumination environment, increase the maximum brightness that can be expressed in the image sensor, and increase the degree of integration of the image sensor.

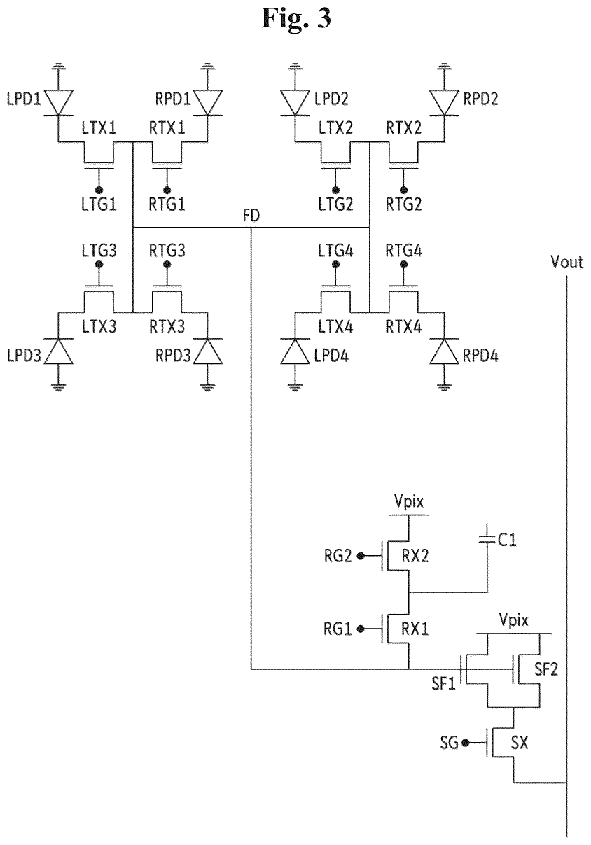

FIG. 3 is a circuit diagram showing a pixel of the image sensor according to an embodiment of the present invention.

Referring to FIG. 3, the pixel array 20 may include a pixel circuit that converts charges generated in each photodiode of a plurality of adjacent pixels into a voltage signal.

For example, the first pixel PX1 may include a first photodiode LPD1 and a second photodiode RPD1, and may include a first transfer transistor LTX1 that connects the first photodiode LPD1 to a floating diffusion region FD, and a second transfer transistor RTX1 that connects the second photodiode RPD1 to the floating diffusion region FD. The first transfer transistor LTX1 may be controlled by a first transfer control signal LTG1. The second transfer transistor RTX1 may be controlled by a first transfer control signal RTG1.

The second pixel PX2 may include a third photodiode LPD2 and a fourth photodiode RPD2, and may include a third transfer transistor LTX2 that connects the third photodiode LPD2 to the floating diffusion region FD, and a fourth transfer transistor RTX2 that connects the fourth photodiode RPD2 to the floating diffusion region FD. The third transfer transistor LTX2 may be controlled by a third transfer control signal LTG2. The fourth transfer transistor RTX2 may be controlled by a first transfer control signal RTG2.

The third pixel PX3 includes a fifth photodiode LPD3 and a sixth photodiode RPD3, and may include a fifth transfer transistor LTX3 that connects the fifth photodiode LPD3 and the floating diffusion region FD, and a sixth transfer transistor RTX3 that connects the sixth photodiode RPD3 and the floating diffusion region FD. The fifth transfer transistor LTX3 may be controlled by a fifth transfer control signal LTG3. The sixth transfer transistor RTX3 may be controlled by a sixth transfer control signal RTG3.

The fourth pixel PX4 includes a seventh photodiode LPD4 and an eighth photodiode RPD4, and may include a seventh transfer transistor LTX4 that connects the seventh photodiode LPD4 and the floating diffusion region FD, and an eighth transfer transistor RTX4 that connects the eighth photodiode RPD4 and the floating diffusion region FD. The seventh transfer transistor LTX4 may be controlled by a seventh transfer control signal LTG4. The eighth transfer transistor RTX4 may be controlled by an eighth transfer control signal RTG4.

The floating diffusion region FD may be connected to the gates of the source-follower transistors SF1 and SF2 that operate as amplifiers.

Input terminals of the first source-follower transistor SF1 and the second source-follower transistor SF2 are connected to a power supply node that supplies a power supply voltage Vpix, and an output signal Vout may be output through the selection transistor SX. When the selection transistor SX is turned on by the selection control signal SG, the source-follower transistors SF1 and SF2 may amplify the voltage of the floating diffusion region FD to output the output signal Vout.

Meanwhile, a first reset transistor RX1 and a second reset transistor RX2 may be connected in series between the floating diffusion region FD and the power supply node. In an embodiment, the first reset transistor RX1 is directly connected to the floating diffusion region FD, and the second reset transistor RX2 is directly connected to the power supply node. In an embodiment, a first capacitor C1 is connected to a node between the first reset transistor RX1 and the second reset transistor RX2. For example, the node may be connected to one end or non-gate terminal of the first reset transistor RX1 such as a drain or source terminal and to one end or non-gate terminal of the second reset transistor RX2 such as a drain or source terminal.

The capacitance of the floating diffusion region FD may vary depending on whether the first reset transistor RX1 is turned on or off. For example, when the first reset transistor RX1 is turned off, the capacitance of the floating diffusion region FD may be determined as a sum of the capacitance of the active regions that provide the floating diffusion region FD in each of the first pixel PX1 to the eighth pixel PX8 and the capacitance of the wiring pattern that connects the active regions. Meanwhile, when the first reset transistor RX1 is turned on, the capacitance may become larger by the sum of the capacitance of the first reset transistor RX1 and the capacitance of the first capacitor C1 than in a case where the first reset transistor RX1 is turned off. Therefore, the conversion gain of the image sensor may be reduced. Thus, the addition of the first capacitor C1 may be used to further reduce the conversion gain.

As a result, in the image sensor according to an embodiment of the present invention, the conversion gain may be adjusted by controlling the turning-on/off of the first reset transistor RX1 and the second reset transistor RX2. When the number of reset transistors is N, the conversion gain of the image sensor may be set to one of N distinct values, each different from the others. For example, N may be an integer greater than or equal to 2. For example, increasing the number of turned on reset transistors may further decrease the conversion gain.

For example, in a low-illuminance environment in which the amount of light flowing into the photodiode is small, the first reset transistor RX1 may be turned off to increase the conversion gain of the image sensor. On the other hand, in a high-illuminance environment in which the amount of light flowing into the photodiode is large, the first reset transistor RX1 may be turned on to increase the capacitance of the floating diffusion region FD, thereby preventing saturation of the floating diffusion region FD. The increased capacitance may decrease the conversion gain.

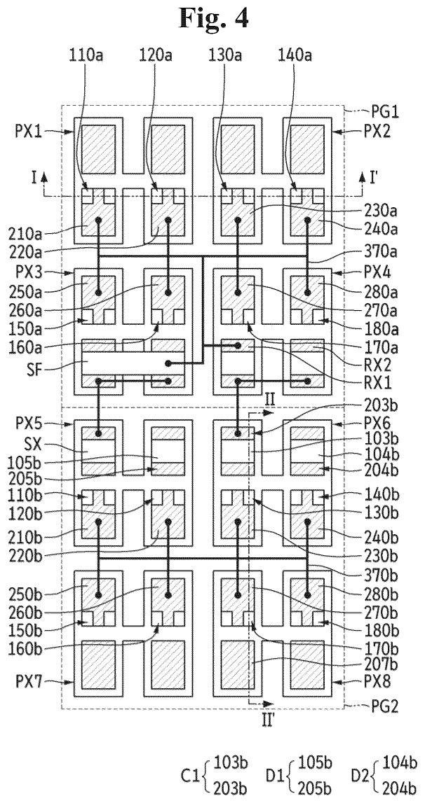

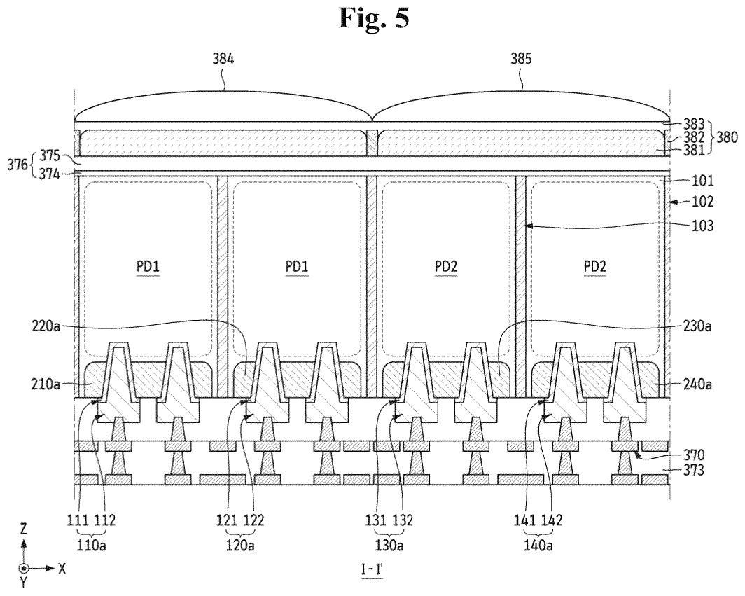

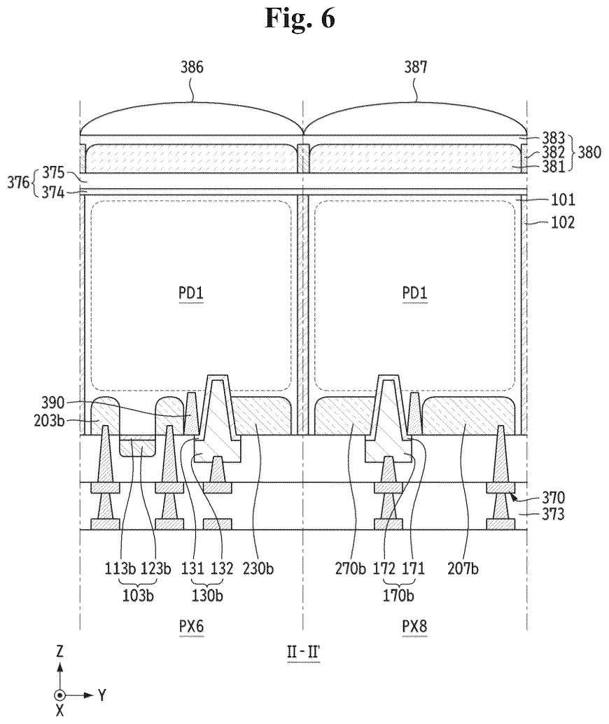

FIG. 4 is a diagram showing some pixels included in the image sensor according to an embodiment of the present invention. FIG. 5 is a cross-sectional view showing a cross section in a I-I′ direction of FIG. 4. FIG. 6 is a cross-sectional view showing a cross section in a II-II′ direction of FIG. 4.

Referring to FIGS. 4 to 6, the pixel circuit shown in FIG. 3 may be disposed on a substrate.

In some embodiments, the first pixel group PG1 includes a first pixel PX1 and a second pixel PX2 that are adjacent to each other in the first direction (X direction), and a third pixel PX3 and a fourth pixel PX4 that are adjacent to the first pixel PX1 and the second pixel PX2 in the second direction (Y direction). The second pixel group PG2 may include a fifth pixel PX5 and a sixth pixel PX6 that are adjacent to each other in the first direction (X direction), and a seventh pixel PX7 and an eighth pixel PX8 that are adjacent to the fifth pixel PX5 and the sixth pixel PX6 in the second direction (Y direction).

Each of the first pixel PX1 to the eighth pixel PX8 may include a first photodiode PD1 and a second photodiode PD2 that are adjacent to each other in the first direction (X direction).

The plurality of pixel regions in which the first pixel PX1 to the eighth pixel PX8 are disposed may be defined by an external pixel separation film 102. The external pixel separation film 102 may extend only in the first direction and the second direction, or may be formed to penetrate the substrate 101. Meanwhile, an internal pixel separation film 103 may be disposed between the first photodiode PD1 and the second photodiode PD2 in each of the first pixel PX1 to the eighth pixel PX8. The internal pixel separation film 103 extends in the second direction (Y direction), and may penetrate the substrate 101 in the same manner as the external pixel separation film 102.

The internal pixel separation film 103 may physically and electrically separate a plurality of photodiodes in the pixel, by using a frontside deep trench isolation (FDTI) pattern.

However, according to an embodiment, the internal pixel separation film 103 has a length shorter than the external pixel separation film 102 in a third direction (Z-axis direction). In this case, charges may move between the first photodiode PD1 and the second photodiode PD2 through a region in which the internal pixel separation film 103 is not formed.

A first transfer gate 110a and a second transfer gate 120a may be disposed in the first pixel PX1 A third transfer gate 130a and a fourth transfer gate 140a may be disposed in the second pixel PX2. A fifth transfer gate 150a and a sixth transfer gate 160a may be disposed in the third pixel PX3. A seventh transfer gate 170a and an eighth transfer gate 180a may be disposed in the fourth pixel PX4. A ninth transfer gate 110b and a tenth transfer gate 120b may be disposed in the fifth pixel PX5, and an eleventh transfer gate 130b and a twelfth transfer gate 140b may be disposed in the sixth pixel PX6. A thirteenth transfer gate 150b and a fourteenth transfer gate 160b may be disposed in the seventh pixel PX7. A fifteenth transfer gate 170b and a sixteenth transfer gate 180b may be disposed in the eighth pixel PX8.

Each of the first transfer gate 110a to the sixteenth transfer gate 180b may be adjacent to one of the first floating active region 210a to the sixteenth floating active region 280b in a direction parallel to an upper face of the substrate 101. For example, in the first pixel PX1, the first transfer gate 110a may be adjacent to the first floating active region 210a, and the second transfer gate 120a may be adjacent to the second floating active region 220a. Similarly, the eleventh transfer gate 130b may be adjacent to the eleventh floating active region 230b in the sixth pixel PX6. The fifteenth transfer gate 170b may be adjacent to the fifteenth floating active region 270b in the eighth pixel PX8. Each of the first floating active region 210a to the sixteenth floating active region 280b may be a region doped with a predetermined impurity.

The first transfer gate 110a to the eighth transfer gate 180a and the first floating active region 210a to the eighth floating active region 280a of FIG. 4 may correspond to the first transfer transistor LTX1 to the eighth transfer transistor RTX4 of FIG. 3.

At least a partial region of each of the transfer gates may be buried in the substrate 101 as shown in FIGS. 5 and 6. Thus, each of the transfer gates included in each of the first pixel PX1 to the eighth pixel PX8 may be adjacent to the first photodiode PD1 or the second photodiode PD2 inside the substrate 101. The first pixel PX1 will be explained as an example. The first transfer gate 110a may include gate insulating layers 111 and 121 and the second transfer gate 120a may include gate electrode layers 112 and 122.

In some embodiments, the first pixel group PG1 and the second pixel group PG2 include a plurality of transistors. Each of the plurality of transistors may include a gate structure and an active region. The transistors disposed in the first pixel group PG1 or the second pixel group PG2 may include, for example, source-follower transistors SF1 and SF2 that operate as amplifiers. Alternatively, the transistors disposed in the first pixel group PG1 or the second pixel group PG2 may include, for example, a first reset transistor RX1, a second reset transistor RX2, and a selection transistor SX that operate as switches. In some embodiments, the source-follower transistor SF is disposed in the third pixel PX3. The source-follower transistor SF may include a first source-follower transistor SF1 and a second source-follower transistor SF2. The first reset transistor RX1 and the second reset transistor RX2 may be disposed in the fourth pixel PX4. The fifth pixel PX5 may include a selection transistor SX and a first dummy transistor D1. The sixth pixel PX6 may include a first capacitor C1 and a second dummy transistor D2. The first dummy transistor D1 may include a first gate structure 105b and a first active region 205b. The second dummy transistor D2 may include a second gate structure 104b and a second active region 204b. The first capacitor C1 may include a third structure gate 103b and a third active region 203b.

The source-follower transistors SF1 and SF2, the selection transistor SX, the first reset transistor RX1, and the second reset transistor RX2 that are disposed in the first pixel group PG1 and the second pixel group PG2, and a first floating active region 210a to a sixteenth floating active region 280b and a first transfer gate 110a to the sixteenth transfer gate 180b that are disposed in the first pixel group PG1 and the second pixel group PG2 may be connected to each other by a plurality of wiring patterns 370 disposed above the substrate 101. For example, as shown in FIG. 4, the first pixel group PG1 may include the source-follower transistors SF1 and SF2 and the reset transistors RX1 and RX2 and the second pixel group PG2 may include the selection transistor SX. The plurality of wiring patterns 370 may include contacts extending in the third direction and metal wirings extending in the first direction and/or the second direction, and may be disposed inside an interlayer insulating layer 373.

In some embodiments, for example, the first floating active region 210a to the eighth floating active region 280a disposed in the first pixel group PG1 may be electrically connected to each other by a first wiring pattern 370a. Accordingly, the first floating diffusion region may be formed. The ninth floating active region 210b to the sixteenth floating active region 280b disposed in the second pixel group PG2 may be electrically connected to each other by a second wiring pattern 370b. Accordingly, the second floating diffusion region may be formed.

The first floating diffusion region of FIG. 4 corresponds to the floating diffusion region FD of FIG. 3. Hereinafter, the term “first floating diffusion region” is changed to a “floating diffusion region”, and a connection relationship of the elements connected to the first floating diffusion region will be described. The floating diffusion region FD may be electrically connected to the gate structure of the first source-follower transistor SF1, the gate structure of the second source-follower transistor SF2, and the active region of the first reset transistor RX1. The active region of the first reset transistor RX1 may be electrically connected to the active region of the second reset transistor RX2 and the active region of the first capacitor C1. The active region of the first source-follower transistor SF1 and the active region of the second source-follower transistor SF2 may be electrically connected to the active region of the selection transistor SX, and an output signal Vout may be output.

Meanwhile, an optical region including a horizontal insulating layer 376, a color filter layer 380 and microlenses 384, 385, 386 and 387 may be provided on the substrate 101. The horizontal insulating layer 376 may include a first horizontal insulating layer 374 and a second horizontal insulating layer 375. In an embodiment, the first horizontal insulating layer 374 that is in contact with the substrate 101 is formed of a material having a higher dielectric constant than the second horizontal insulating layer 375. In an embodiment, the first horizontal insulating layer 374 has a thickness (e.g., in a third or Z direction) smaller than that of the second horizontal insulating layer 375, and the first horizontal insulating layer 374 may cure some of the defects of the substrate 101.

The color filter layer 380 may include a color filter 381, a filter separation film 382, and a planarization layer 383. The filter separation film 382 extends in the first direction and the second direction similar to the external pixel separation film 103. Thus, the color filter 381 may be arranged along a plurality of pixel regions. The planarization layer 383 may be disposed on the color filter 381. A microlens 384 may be disposed on the planarization layer 383. The microlens 384 refracts incoming light and directs it toward the color filter 380, which selectively allows light within a specific wavelength band to reach the photodiodes PD1 and PD2.

As shown in FIG. 6, an element separation layer 390 disposed between the transistors disposed on the substrate 101 may be formed in the substrate 101. The element separation layer 390 may reduce leakage current between the source region and the drain region of each transistor or leakage current occurring between different transistors. The element separation layer 390 may include a silicon oxide film (SiO₂).

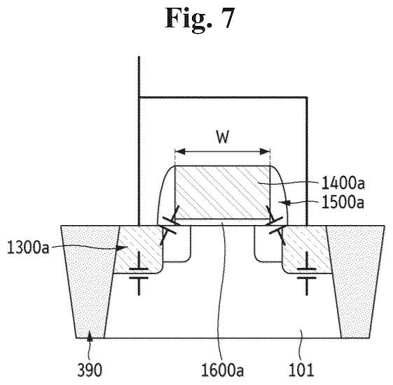

FIGS. 7 to 13 are cross-sectional views showing a capacitor included in a pixel of an image sensor according to an embodiment.

Referring to FIGS. 3, 4, 6 and 7, the first capacitor C1 disposed in the sixth pixel PX6 inside the second pixel group PG2 may be implemented as a MOSFET including a gate structure and an active region, in the manner similar to the first and second source-follower transistors SF2, the selection transistor SX, and the first and second reset transistors RX2.

In some embodiments, the gate structure is disposed on the substrate 101. In some embodiments, the substrate 101 includes silicon (Si). In some other embodiments, the substrate 101 includes a semiconductor element such as germanium (Ge), or a compound semiconductor material such as silicon carbide (SiC), gallium arsenide (GaAs), indium arsenide (InAs), and indium phosphide (InP). In some embodiments, the substrate 101 has a silicon on insulator (SOI) structure. For example, the substrate 101 may include a Buried Oxide Layer (BOX) layer. Furthermore, the substrate 101 may include a conductive region, for example, an impurity-doped well or an impurity-doped structure. The substrate 101 may constitute a P-type substrate or an N-type substrate depending on the type of impurity ions doped.

The gate structure may include a dielectric layer 1600a, a gate electrode 1400a, and a spacer 1500a. The dielectric layer 1600a may be disposed between the substrate 101 and the gate electrode 1400a. For example, an upper surface of the dielectric layer 1600a may contact the gate electrode 1400a and a lower surface of the dielectric layer 1600a may contact the substrate 101. The dielectric layer 1600a may be formed of an oxide such as silicon oxide (SiO₂) or a nitride such as silicon nitride (SINx). The dielectric layer 1600a may also be formed of a dielectric material having a high dielectric constant value (high-k). For example, the dielectric layer 1600a may be hafnium oxide (HfO2), hafnium silicon oxide (HfSiO4), lanthanum oxide (La2O3), lanthanum aluminum oxide (LaAlO3), zirconium oxide (ZrO2), zirconium silicon oxide (ZrSiO4), tantalum oxide (Ta2O5), titanium oxide (TiO2), strontium titanium oxide (SrTiO3), yttrium oxide (Y2O3), aluminum oxide (Al2O3), red scandium tantalum oxide (PbSc0.5T0.5aO3), or red zinc niobate (PbZnNbO3). In some embodiments, the dielectric layer 1600a may be formed of metal oxides such as hafnium oxide (HfO2), zirconium oxide (ZrO2), titanium oxide (TiO2), and aluminum oxide (Al2O3), and silicates or aluminates thereof.

The gate electrode 1400a may be formed of a metal. The spacer 1500a may be formed on side walls of the dielectric layer 1600a and the gate electrode 1400a. Such a spacer 1500a may be formed of silicon nitride or silicon oxide. For example, the spacer 1500a may be formed of silicon nitride (SiNx).

The active region 1300a may be formed by doping impurity ions inside the substrate 101. A tetravalent carbon group element may be used as the impurity ion to implement a P-channel MOS, i.e., a PMOS, and a divalent alkaline earth metal element may be used as the impurity ion to implement an N-channel MOS, i.e., an NMOS. However, when implementing a specific PMOS or NMOS, the impurity ion is not limited to the carbon group or alkaline earth metal, and elements of other groups or metals may be used as the impurity ion.

In some embodiments, both the source and drain regions of the first capacitor C1 may be connected to the first reset transistor RX1 and the second reset transistor RX2. For example, the first capacitor C1 may be implemented as a MOSFET configured to function as a capacitor.

In some embodiments, the capacitance may be adjusted by adjusting a width W of the gate structure of the first capacitor C1. For example, when the first capacitor C1 is implemented as a MOSFET, the capacitance may be adjusted by adjusting a width W of the gate structure of the MOSFET.

The first capacitor C1 may be connected to the floating diffusion region FD when the first reset transistor RX1 is turned on. Accordingly, the conversion gain of the image sensor may be reduced.

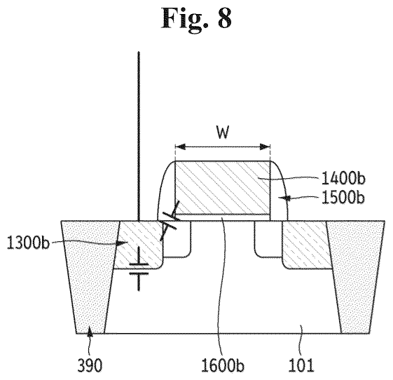

To simplify the explanation, components in FIGS. 8 to 13 that are identical to those in the configuration shown in FIG. 7 will not be described again, and the focus will primarily be on the differences.

Referring to FIG. 8, in some embodiments, only one of the source or drain regions of the first capacitor C1 is connected to the first reset transistor RX1 and the second reset transistor RX2. Accordingly, the capacitance of the first capacitor C1 can be adjusted. When the first reset transistor RX1 is turned on, the first capacitor C1 is connected to the floating diffusion region FD, and the conversion gain of the image sensor may be reduced.

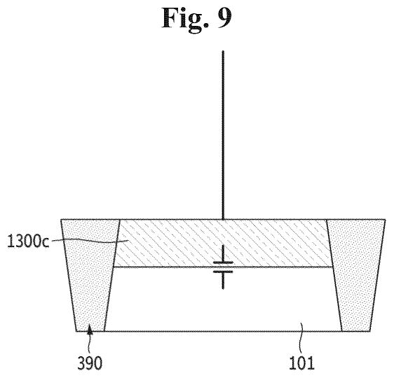

Referring to FIGS. 6 and 9, in some embodiments, the first capacitor C1 does not include a gate structure, and a capacitance is formed between the active region 1300c and the substrate 101. For example, in this embodiment, the first capacitor C1 has two conductive plates separated by a dielectric material and is not a MOS capacitor. When the first reset transistor RX1 is turned on, the first capacitor C1 is connected to the floating diffusion region FD, and the conversion gain of the image sensor may be reduced.

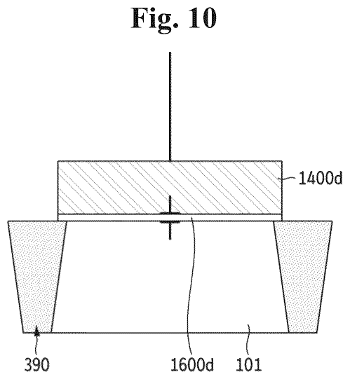

Referring to FIGS. 6 and 10, in some embodiments, the first capacitor C1 is a MOS capacitor in which a capacitance is formed between the gate structure including the polysilicon layer 1400d and the dielectric layer 1600d and the substrate 101. When the first reset transistor RX1 is turned on, the first capacitor C1 is connected to the floating diffusion region FD, and the conversion gain of the image sensor may be reduced.

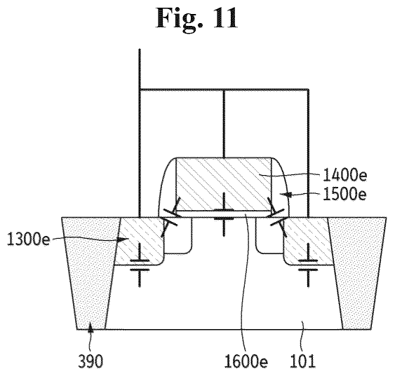

Referring to FIGS. 6 and 11, in some embodiments, the first capacitor C1 is a MOS capacitor in which a capacitance is formed between the gate structure including the dielectric layer 1600e, the gate electrode 1400e, and the spacer 1500e and the substrate 101. In some embodiments, both the source and drain region of the first capacitor C1 and the gate structure is connected to the first reset transistor RX1 and the second reset transistor RX2. When the first reset transistor RX1 is turned on, the first capacitor C1 is connected to the floating diffusion region FD, and the conversion gain of the image sensor may be reduced.

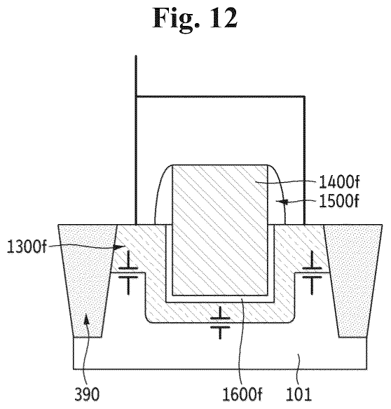

Referring to FIGS. 6 and 12, in some embodiments, the first capacitor C1 is a MOS capacitor having a recessed structure in which the substrate 101 below the gate structure is recessed. The gate structure may include a dielectric layer 1600f, a gate electrode 1400f, and a spacer 1500f. In some embodiments, both the source and drain regions of the first capacitor C1 are connected to the first reset transistor RX1 and the second reset transistor RX2. When the first reset transistor RX1 is turned on, the first capacitor C1 is connected to the floating diffusion region FD, and the conversion gain of the image sensor may be reduced.

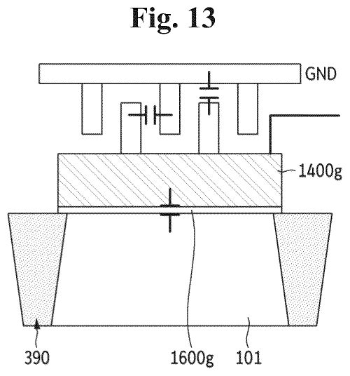

Referring to FIGS. 6 and 13, in some embodiments, The first capacitor C1 in FIG. 13 may include a dielectric layer 1600g, a gate electrode 1400g and a GND layer. The first capacitor C1 is configured to have a structure where a capacitance is formed between metal layers that comprise the GND layer and the gate electrode 1400g. When the first reset transistor RX1 is turned on, the first capacitor C1 is connected to the floating diffusion region FD, and the conversion gain of the image sensor may be reduced.

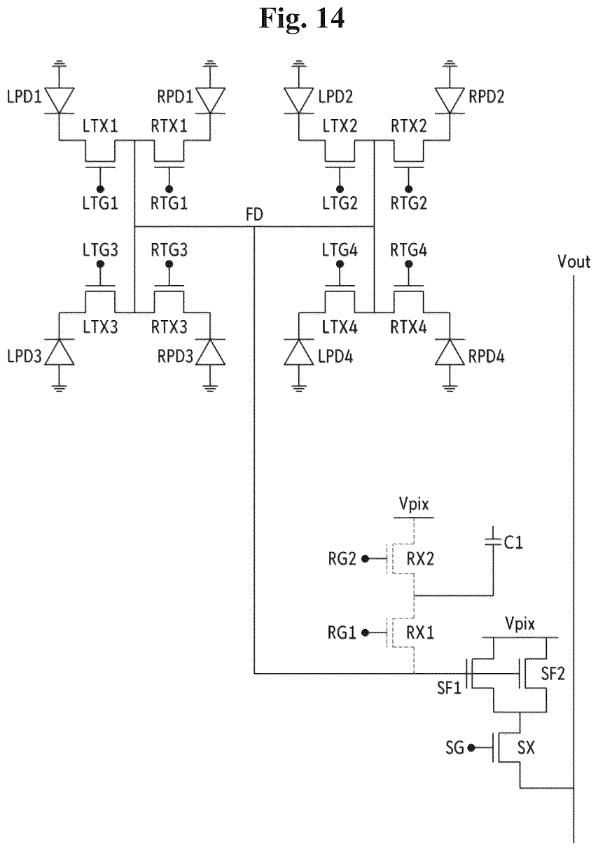

FIGS. 14 to 18 are diagrams for explaining the operation of an image sensor according to an embodiment.

Referring to FIG. 14, while the charges generated in each of the first to fourth photodiodes PD1 to PD4 are moving to the floating diffusion region FD, the first reset transistor RX1 may be turned off (e.g., RX1 is illustrated with dotted lines).

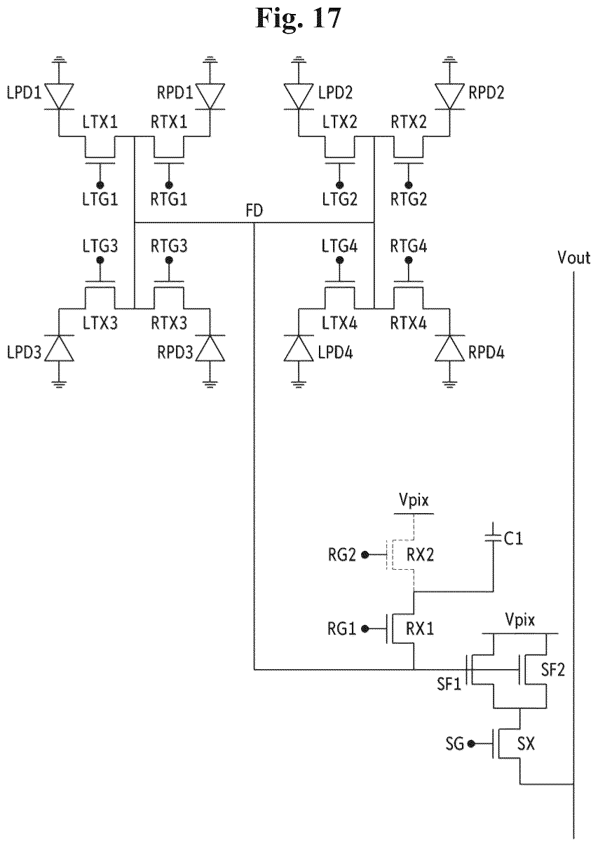

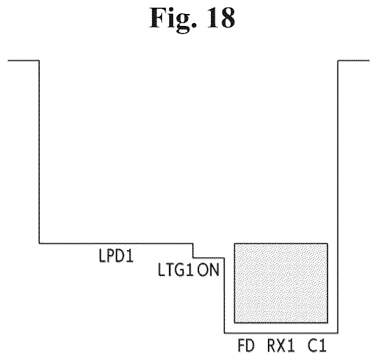

Therefore, the capacitance of the first reset transistor RX1 and the first capacitor C1 is not added to the capacitance of the floating diffusion region FD, and the conversion gain of the image sensor may be larger than a case described below in FIGS. 17 and 18.

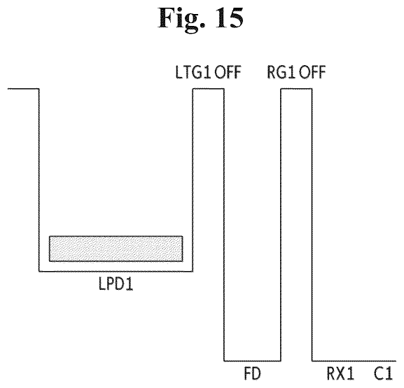

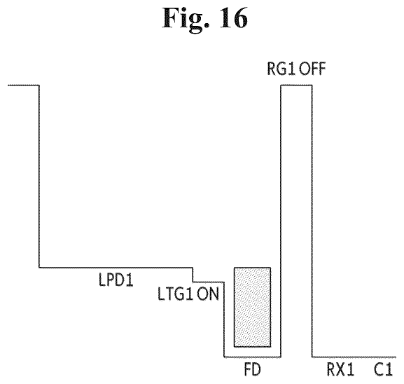

Referring to FIGS. 15 and 16, when the first transfer transistor LTX1 is maintained in a turned-off state by the first transfer control signal LTG1, the first photodiode LPD1 may be exposed to light.

When the first transfer transistor LTX1 is turned on, the charge of the first photodiode LPD1 may move to the floating diffusion region FD. However, because the first reset transistor RX1 is turned off, the floating diffusion region FD is not connected to the first capacitor C1.

Referring to FIG. 17, while the charges generated in each of the first to fourth photodiodes PD1 to PD4 are moving to the floating diffusion region FD, the first reset transistor RX1 may be maintained in a turned-on state (e.g., RX1 is illustrated with a solid line). Therefore, the capacitance of the first reset transistor RX1 and the first capacitor C1 is added to the capacitance of the floating diffusion region FD, and the conversion gain of the image sensor may be reduced compared to the case described in FIGS. 14 to 16.

Referring to FIG. 18, when the first transfer transistor LTX1 is turned on, the charge of the first photodiode LPD1 may move to the first reset transistor RX1 and the first capacitor C1 along the floating diffusion region FD.

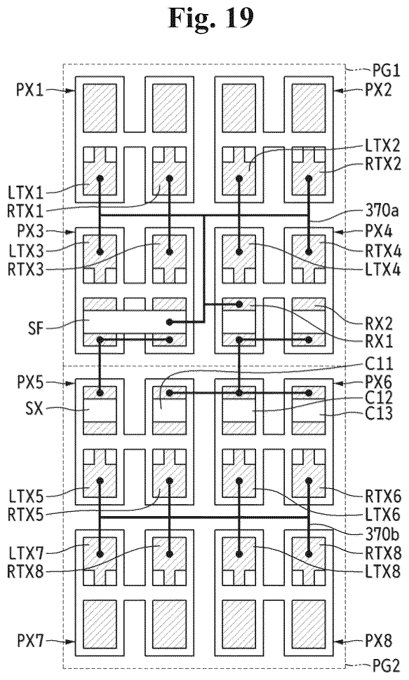

FIGS. 19 to 21 are diagrams showing some pixels included in the image sensor according to an embodiment of the present invention. Since FIGS. 19 to 21 correspond to FIG. 3, the differences from FIG. 3 will be mainly explained for convenience of explanation.

Referring to FIGS. 3 and 19, in some embodiments, the third pixel PX3 may include a first source-follower transistor SF 1 and a second source-follower transistor SF2 (e.g., illustrated as SF). The fourth pixel PX4 may include a first reset transistor RX1 and a second reset transistor RX2. The fifth pixel PX5 may include a selection transistor SX and an eleventh sub-capacitor C11. The sixth pixel PX6 may include a twelfth sub-capacitor C12 and a thirteenth sub-capacitor C13. In an embodiment, the sum of the capacitances of the eleventh to thirteenth sub-capacitors C11 to C13 are equal to the capacitance of the first capacitor C1.

The floating diffusion region FD may be electrically connected to the gate structure of the first source-follower transistor SF1, the gate structure of the second source-follower transistor SF2, and the active region of the first reset transistor RX1. The active region of the first reset transistor RX1 may be electrically connected to the active region of the second reset transistor RX2 and the active region of the eleventh sub-capacitor C 11 to the active region of the thirteenth sub-capacitor C13. The active region of the first source-follower transistor SF1 and the active region of the second source-follower transistor SF2 may be electrically connected to the active region of the selection transistor SX.

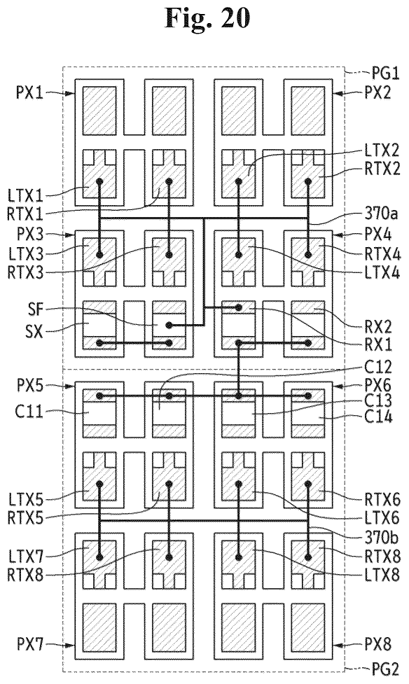

Referring to FIGS. 6 and 20, in some embodiments, the third pixel PX3 may include a source-follower transistor SF and a selection transistor SX. The fourth pixel PX4 may include a first reset transistor RX1 and a second reset transistor RX2. The fifth pixel PX5 may include an eleventh sub-capacitor C11 and a twelfth sub-capacitor C12. The sixth pixel PX6 may include a thirteenth sub-capacitor C13 and a fourteenth sub-capacitor C14. In an embodiment, the sum of the capacitances of the eleventh sub-capacitor C11 to the fourteenth sub-capacitor C14 is equal to the capacitance of the first capacitor C1.

The floating diffusion region FD may be electrically connected to the gate structure of the source-follower transistor SF and the active region of the first reset transistor RX1. The active region of the first reset transistor RX1 may be electrically connected to the active region of the second reset transistor RX2 and the active region of the eleventh sub-capacitor C11 to the active region of the fourteenth sub-capacitor C14. The active region of the source-follower transistor SF may be electrically connected to the active region of the selection transistor SX.

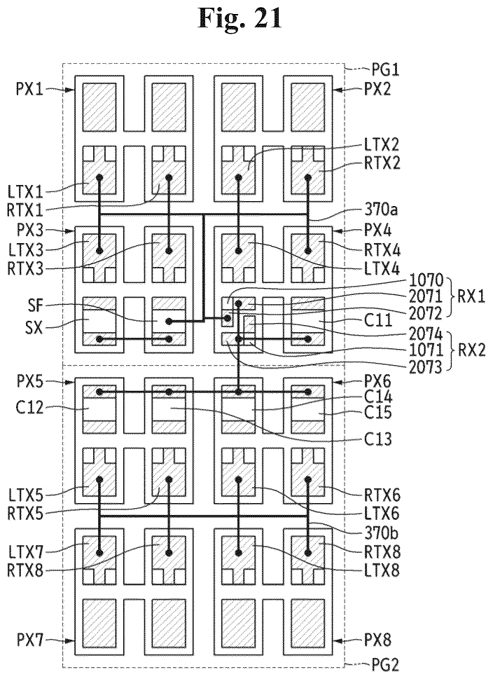

Referring to FIGS. 6 and 21, in some embodiments, the third pixel PX3 includes a source-follower transistor SF and a selection transistor SX. The fourth pixel PX4 may include a first reset transistor RX1, a second reset transistor RX2, and an eleventh sub-capacitor C11. The fifth pixel PX5 may include a twelfth sub-capacitor C12 and a thirteenth sub-capacitor C13. The sixth pixel PX6 may include a fourteenth sub-capacitor C14 and a fifteenth sub-capacitor C15. In an embodiment, the sum of the capacitances of the eleventh sub-capacitor C11 to the fifteenth sub-capacitor C15 is equal to the capacitance of the first capacitor C1.

In an embodiment, the area of each of the transistors disposed in the fourth pixel PX4 is smaller than the area of each of the transistors disposed in the third pixel PX3. For example, the gate structure disposed in the third pixel PX3 may have a larger area than the gate structure disposed in the fourth pixel PX4. Also, the active region disposed in the third pixel PX3 may have a larger area than the active region disposed in the fourth pixel PX4. In an embodiment, fewer transistors are disposed in the third pixel PX3 than in the fourth pixel PX4 so that the source-follower transistor SF has a larger area than each of the first reset transistor RX1 and the second reset transistor RX2.

A pair of active regions included in each of the first and second reset transistors RX1 and RX2 of the fourth pixel PX4 may extend in different directions from each other to dispose more transistors in the same or similar area. The first reset transistor RX1 may include a gate structure 1070, a first active region 2071 and a second active region 2072. The gate structure 1070, the first active region 2071 and the second active region 2072 are arranged in an L shape. The second reset transistor RX2 may include a gate structure 1071, a first active region 2073 and a second active region 2074. The gate structure 1071, the first active region 2073 and the second active region 2074 are arranged in an L shape For example, in the first reset transistor RX1, the first active region 2071 may extend in the first direction (X direction), and the second active region 2072 may extend in the second direction (Y direction). For example, in the second reset transistor RX2, the first active region 2073 may extend in the first direction (X direction), and the second active region 2074 may extend in the second direction (Y direction).

The floating diffusion region FD may be electrically connected to the gate structure of the source-follower transistor SF and the active region of the first reset transistor RX1. The active region of the first reset transistor RX1 may be electrically connected to the active region of the second reset transistor RX2 and the active region of the eleventh sub-capacitor C11 to the active region of the fifteenth sub-capacitor C15. The active region of the source-follower transistor SF may be electrically connected to the active region of the selection transistor SX.

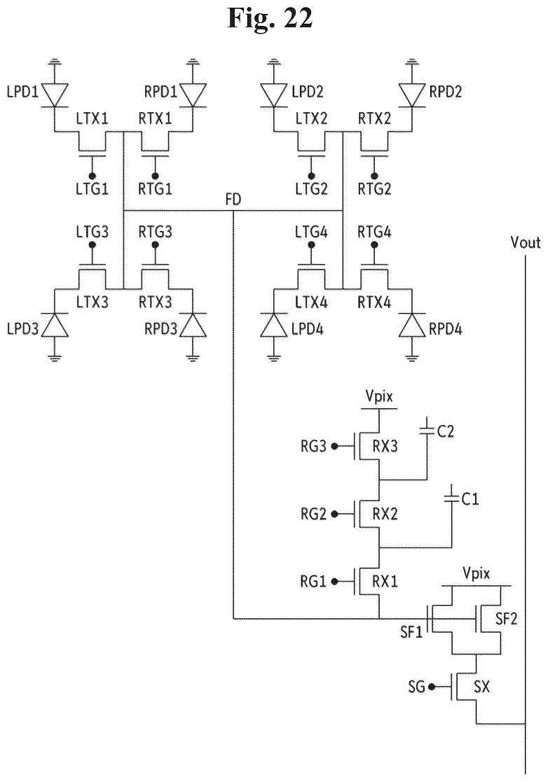

FIG. 22 is a circuit diagram showing a pixel of the image sensor according to an embodiment of the present invention.

Referring to FIG. 22, the pixel array 20 may include a pixel circuit that converts charges generated in each photodiode of a plurality of adjacent pixels into a voltage signal.

For example, the first pixel PX1 includes a first photodiode LPD1 and a second photodiode RPD1, and may include a first transfer transistor LTX1 that connects the first photodiode L PD1 to the floating diffusion region FD, and a second transfer transistor RTX1 that connects the second photodiode RPD1 to the floating diffusion region FD. The first transfer transistor LTX1 may be controlled by the first transfer control signal LTG1. The second transfer transistor RTX1 may be controlled by the first transfer control signal RTG1.

The second pixel PX2 includes a third photodiode LPD2 and a fourth photodiode RPD2, and may include a third transfer transistor LTX2 that connects the third photodiode LPD2 and the floating diffusion region FD, and a fourth transfer transistor RTX2 that connects the fourth photodiode RPD2 and the floating diffusion region FD. The third transfer transistor LTX2 may be controlled by the third transfer control signal LTG2. The fourth transfer transistor RTX2 may be controlled by the first transfer control signal RTG2.

The third pixel PX3 includes a fifth photodiode LPD3 and a sixth photodiode RPD3, and may include a fifth transfer transistor LTX3 that connects the fifth photodiode LPD3 and the floating diffusion region FD, and a sixth transfer transistor RTX3 that connects the sixth photodiode RPD3 and the floating diffusion region FD. The fifth transfer transistor LTX3 may be controlled by a fifth transfer control signal LTG3. The sixth transfer transistor RTX3 may be controlled by the sixth transfer control signal RTG3.

The fourth pixel PX4 includes a seventh photodiode LPD4 and an eighth photodiode RPD4, and may include a seventh transfer transistor LTX4 that connects the seventh photodiode LPD4 and the floating diffusion region FD, and an eighth transfer transistor RTX4 that connects the eighth photodiode RPD4 and the floating diffusion region FD. The seventh transfer transistor LTX4 may be controlled by a seventh transfer control signal LTG4. The eighth transfer transistor RTX4 may be controlled by an eighth transfer control signal RTG4.

The floating diffusion region FD may be connected to the gates of the source-follower transistors SF1 and SF2 that operate as amplifiers.

The input terminals of the first source-follower transistor SF1 and the second source-follower transistor SF2 are connected to a power supply node that supplies a power supply voltage Vpix. An output signal Vout may be output through the selection transistor SX. When the selection transistor SX is turned on by the selection control signal SG, the source-follower transistors SF1 and SF2 may amplify the voltage of the floating diffusion region FD to output the output signal Vout.

In an embodiment, the first reset transistor RX1, the second reset transistor RX2, and the third reset transistor RX3 are connected in series between the floating diffusion region FD and the power supply node. In an embodiment, the first reset transistor RX1 is directly connected to the floating diffusion region FD, and the third reset transistor RX3 is directly connected to the power supply node. The second reset transistor RX2 may be connected between the first reset transistor RX1 and the third reset transistor RX3. A first capacitor C1 may be connected between the first reset transistor RX1 and the second reset transistor RX2. A second capacitor C2 may be connected between the second reset transistor RX2 and the third reset transistor RX3.

The capacitance of the floating diffusion region FD may vary depending on whether the first reset transistor RX1 and the second reset transistor RX2 are turned on or off. For example, when the first reset transistor RX1 and the second reset transistor RX2 are both turned off, the capacitance of the floating diffusion region FD may be determined by the sum of the capacitance of the active regions that provide the floating diffusion region FD in each of the first pixel PX1 and the second pixel PX2 and the capacitance of the wiring pattern that connects the active regions. Meanwhile, when the first reset transistor RX1 is turned on and the second reset transistor RX2 is turned off, the capacitance of the floating diffusion region FD may become larger by the sum of the capacitance of the first reset transistor RX1 and the capacitance of the first capacitor C1 than in a case where the first reset transistor RX1 and the second reset transistor RX2 are both turned off.

Therefore, the conversion gain of the image sensor may be reduced. Also, when the first reset transistor RX1 and the second reset transistor RX2 are both turned on, the capacitance of the floating diffusion region FD may become larger by the sum of the capacitance of the second reset transistor RX2 and the capacitance of the second capacitor C2 than in a case where the first reset transistor RX1 is turned on and the second reset transistor RX2 is turned off. Therefore, the conversion gain of the image sensor may be reduced.

Consequently, in the image sensor according to an embodiment of the present invention, the conversion gain may be adjusted by controlling the turning-on/off of the first reset transistor RX1 and the second reset transistor RX2. When the number of reset transistors is N, the conversion gain of the image sensor may be set to one of N distinct values, each different from the others.

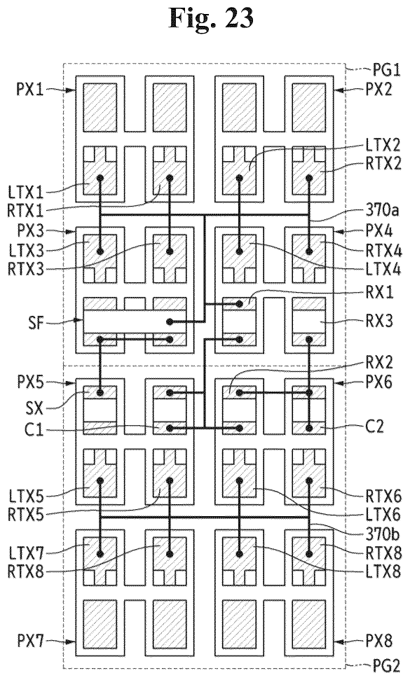

For example, in a low-illumination environment in which the amount of light flowing into the photodiode is small, both the first reset transistor RX1 and the second reset transistor RX2 may be turned off to increase the conversion gain of the image sensor. On the other hand, in a high-illumination environment in which the amount of light flowing into the photodiode is large, both the first reset transistor RX1 and the second reset transistor RX2 may be turned on to increase the capacitance of the floating diffusion region FD, thereby preventing saturation. FIGS. 23 to 29 are diagrams showing some pixels included in the image sensor according to an embodiment of the present invention.

Referring to FIGS. 22 and 23, the pixel circuit shown in FIG. 22 may be disposed on a substrate. In some embodiments, the first transfer transistor LTX1 and the second transfer transistor RTX1 are disposed in the first pixel PX1. The third transfer transistor LTX2 and the fourth transfer transistor RTX2 may be disposed in the second pixel PX2. The fifth transfer transistor LTX3 and the sixth transfer transistor RTX3 may be disposed in the third pixel PX3. The seventh transfer transistor LTX4 and the eighth transfer transistor RTX4 may be disposed in the fourth pixel PX4. The ninth transfer transistor LTX5 and the tenth transfer transistor RTX5 may be disposed in the fifth pixel PX5. The eleventh transfer transistor LTX6 and the twelfth transfer transistor RTX6 may be disposed in the sixth pixel PX6. The thirteenth transfer transistor LTX7 and the fourteenth transfer transistor RTX7 may be disposed in the seventh pixel PX7. The fifteenth transfer transistor LTX8 and the sixteenth transfer transistor RTX8 may be disposed in the eighth pixel PX8.

The source-follower transistor SF may be disposed in the third pixel PX3. The first reset transistor RX1 and the third reset transistor RX3 may be disposed in the fourth pixel PX4. The selection transistor SX and the first capacitor C1 may be disposed in the fifth pixel PX5. The second reset transistor RX2 and the second capacitor C2 may be disposed in the sixth pixel PX6.

In some embodiments, the capacitance of the second capacitor C2 is greater than the capacitance of the first capacitor C1.

In some embodiments, for example, the first transfer transistor LTX1 to the eighth transfer transistor RTX4 disposed in the first pixel group PG1 may be electrically connected to each other by the first wiring pattern 370a. Accordingly, the first floating diffusion region may be formed. Also, the ninth transfer transistor LTX5 to the sixteenth transfer transistor RTX8 disposed in the second pixel group PG2 may be electrically connected to each other by the second wiring pattern 370b. Accordingly, the second floating diffusion region may be formed. The first floating diffusion region of FIG. 23 corresponds to the floating diffusion region FD of FIG. 22. Hereinafter, the term “first floating diffusion region” is changed to a “floating diffusion region”, and a connection relationship of the elements connected to the first floating diffusion region will be explained.

The floating diffusion region FD may be electrically connected to the gate structure of the source-follower transistor SF and the active region of the first reset transistor RX1. The active region of the first reset transistor RX1 may be electrically connected to the active region of the second reset transistor RX2 and the active region of the first capacitor C1. The active region of the second reset transistor RX2 may be electrically connected to the active region of the third reset transistor RX3 and the active region of the second capacitor C2. The active region of the source-follower transistor SF may be electrically connected to the active region of the selection transistor SX.

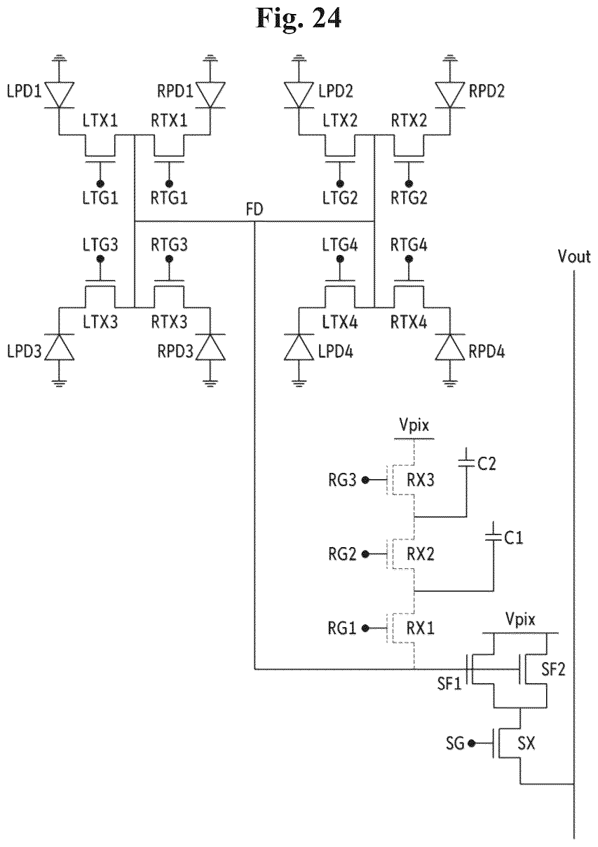

FIGS. 24 to 29 are diagrams showing some pixels included in the image sensor according to an embodiment of the present invention.

Referring to FIG. 24, while the charges generated in each of the first to fourth photodiodes PD1 to PD4 are moving to the floating diffusion region FD, the first reset transistor RX1 and the second reset transistor RX2 may be turned off.

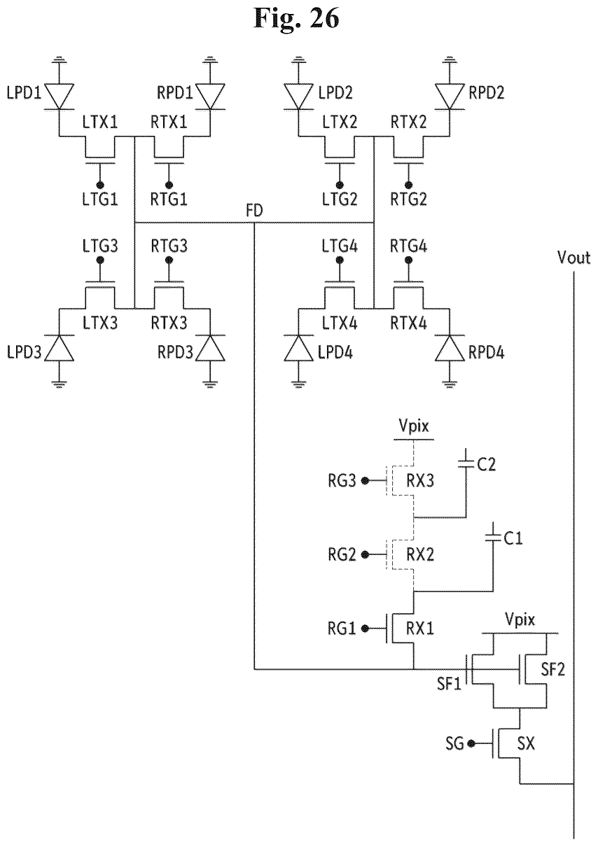

Therefore, the capacitances of the first reset transistor RX1, the second reset transistor RX2, the first capacitor C1, and the second capacitor C2 are not added to the capacitance of the floating diffusion region, and the conversion gain of the image sensor may be larger than in a case to be explained below in FIGS. 26 to 29.

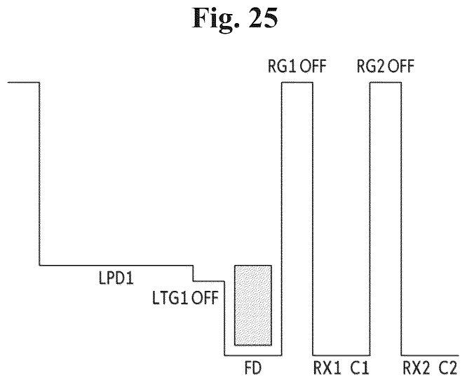

Referring to FIG. 25, when the first transfer transistor LTX1 is turned on, the charge of the first photodiode L PD1 may move to the floating diffusion region FD.

Referring to FIG. 26, while the charges generated in each of the first to fourth photodiodes PD1 to PD4 are moving to the floating diffusion region FD, the first reset transistor RX1 may be turned on, and the second reset transistor RX2 may be turned off. Therefore, the capacitances of the first reset transistor RX1 and the first capacitor C1 are added to the capacitance of the floating diffusion region FD, and the conversion gain of the image sensor may be reduced compared to the case explained in FIGS. 24 and 25.

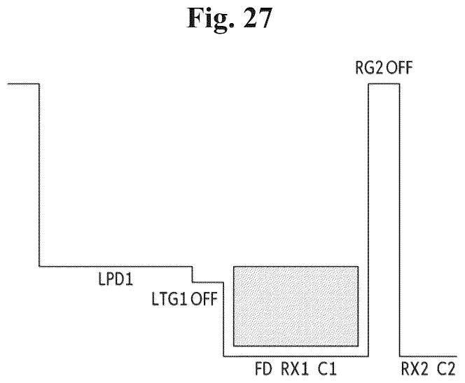

Referring to FIG. 27, when the first transfer transistor LTX1 is turned on, the charge of the first photodiode LPD1 may move to the first reset transistor RX1 and the first capacitor C1 along the floating diffusion region FD.

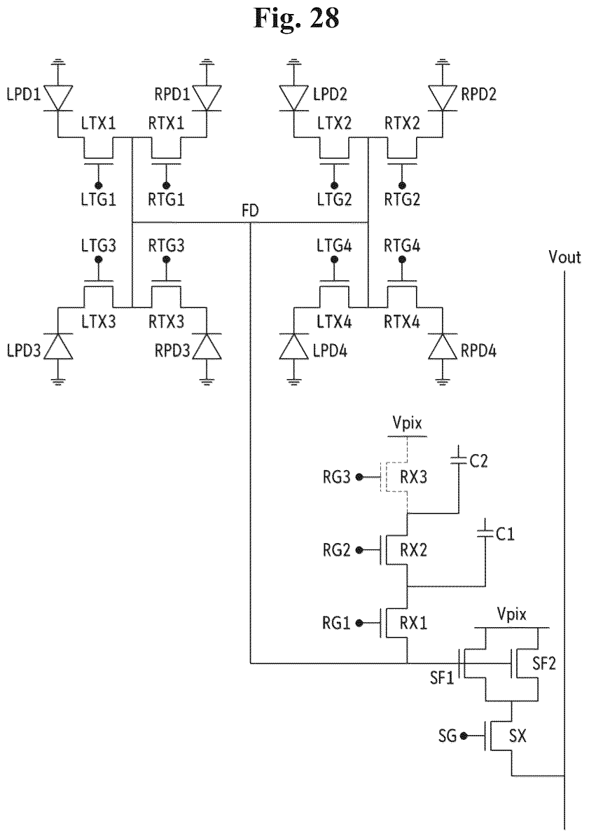

Referring to FIG. 28, while the charges generated in each of the first to fourth photodiodes PD1 to PD4 are moving to the floating diffusion region FD, both the first reset transistor RX1 and the second reset transistor RX2 may be turned on. Therefore, the capacitances of the first reset transistor RX1, the first capacitor C1, the second reset transistor RX2, and the second capacitor C2 are added to the capacitance of the floating diffusion region FD, and the conversion gain of the image sensor may be reduced compared to the case described in FIGS. 26 and 27.

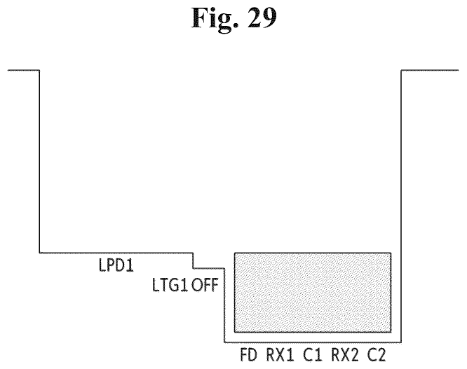

Referring to FIG. 29, when the first transfer transistor LTX1 is turned on, the charge of the first photodiode LPD1 may move to the first reset transistor RX1, the second reset transistor RX2, the first capacitor C1, and the second capacitor C2 along the floating diffusion region FD.

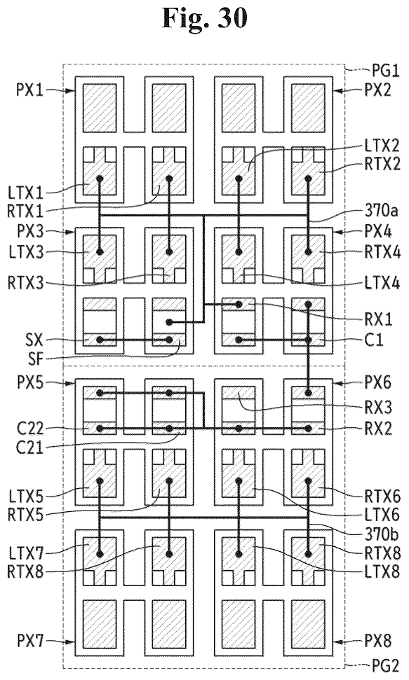

FIGS. 30 to 32 are diagrams showing some pixels included in the image sensor according to an embodiment of the present invention. Because FIGS. 30 to 32 are diagrams corresponding to FIG. 23, the explanation will primarily focus on the differences from FIG. 23 for simplicity.

Referring to FIGS. 22 and 30, the third pixel PX3 may include a source-follower transistor SF and a selection transistor SX. The fourth pixel PX4 may include a first reset transistor RX1 and a first capacitor C1. The fifth pixel PX5 may include a twenty-first sub-capacitor C21 and a twenty-second sub-capacitor C22. In an embodiment, the sum of the capacitances of the twenty-first sub-capacitor C21 and the twenty-second sub-capacitor C22 is equal to the capacitance of the second capacitor C2. The sixth pixel PX6 may include a second reset transistor RX2 and a third reset transistor RX3.

A first floating diffusion region FD may be electrically connected to the gate structure of the source-follower transistor SF and the active region of the first reset transistor RX1. The active region of the first reset transistor RX1 may be electrically connected to the active region of the second reset transistor RX2 and the active region of the first capacitor C1. The active region of the second reset transistor RX2 may be electrically connected to the active regions of the twenty-first sub-capacitor C21 and the twenty-second sub-capacitor C22, and the active region of the third reset transistor RX3. The active region of the source-follower transistor SF may be electrically connected to the active region of the selection transistor SX.

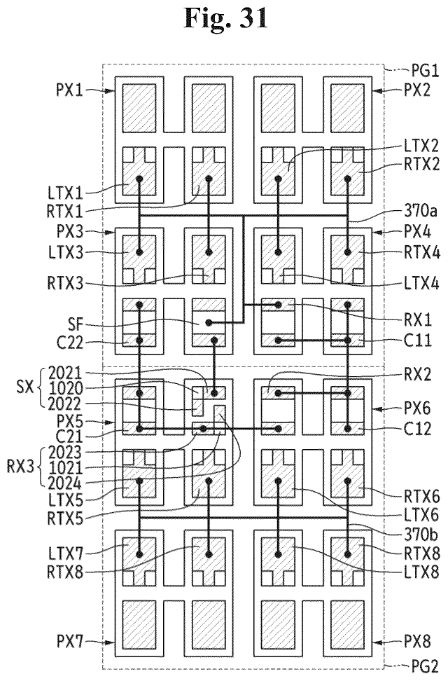

Referring to FIGS. 23 and 31, the third pixel PX3 may include a source-follower transistor SF and a twenty-second sub-capacitor C22. The fourth pixel PX4 may include a first reset transistor RX1 and an eleventh sub-capacitor C11. The fifth pixel PX5 may include a twenty-first sub-capacitor C21, a third reset transistor RX3, and a selection transistor SX. The sixth pixel PX6 may include a second reset transistor RX2 and a twelfth sub-transistor C12. In an embodiment, the sum of the capacitances of the eleventh sub-capacitor C11 and the twelfth sub-capacitor C12 is equal to the capacitance of the first capacitor C1. In an embodiment, the sum of the capacitances of the twenty-first sub-capacitor C21 and the twenty-second sub-capacitor C22 is equal to the capacitance of the second capacitor C2.

In an embodiment, the areas of each of the transistors disposed in the fifth pixel PX5 is smaller than the areas of each of the transistors disposed in the fourth pixel PX4 or the sixth pixel PX6. For example, the gate structure disposed in the fifth pixel PX5 may have a larger area than the gate structure disposed in the fourth pixel PX4 or the sixth pixel PX6. Also, the active region disposed in the fifth pixel PX5 may have a larger area than the active region disposed in the fourth pixel PX4 or the sixth pixel PX6. In an embodiment, fewer transistors are disposed in the third pixel PX3 than in the fifth pixel PX5 so that the source-follower transistor SF may have a larger area than each of the first reset transistor RX1 and the second reset transistor RX2.

To dispose more transistors in the same or similar area, a pair of active regions included in each of the selection transistor SX and the third reset transistor RX3 of the fifth pixel PX5 may extend in different directions from each other. The selection transistor SX may include a gate structure 1020, a first active region 2021 and a second active region 2022. The gate structure 1020, the first active region 2021 and the second active region 2022 are arranged in an L shape. The third reset transistor RX3 may include a gate structure 1021, a first active region 2023 and a second active region 2024. The gate structure 1021, the first active region 2023 and the second active region 2024 are arranged in an L shape. For example, in the selection transistor SX, the first active region 2021 may extend in the first direction (X direction), and the second active region 2022 may extend in the second direction (Y direction). For example, in the third reset transistor RX3, the first active region 2023 may extend in the first direction (X direction), and the second active region 2024 may extend in the second direction (Y direction).

The first floating diffusion region FD may be electrically connected to the gate structure of the source-follower transistor SF and the active region of the first reset transistor RX1. The active region of the first reset transistor RX1 may be electrically connected to the active region of the second reset transistor RX2, and the active regions of the eleventh sub-capacitor C11 and the twelfth sub-capacitor C12. The active region of the second reset transistor RX2 may be electrically connected to the active regions of the twenty-first sub-capacitor C21 and the twenty-second sub-capacitor C22, and the active region of the third reset transistor RX3. The active region of the source-follower transistor SF may be electrically connected to the active region of the selection transistor SX.

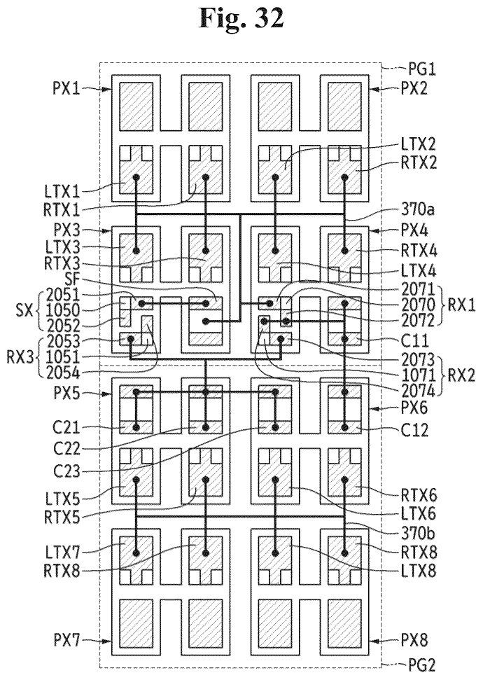

Referring to FIGS. 23 and 32, the third pixel PX3 may include a source-follower transistor SF, a selection transistor SX, and a third reset transistor RX3. The selection transistor SX may include layers 1050, 2051 and 2052 arranged in an L shape and the third reset transistor RX3 may include layers 1051, 2053 and 2054 arranged in an L shape. The fourth pixel PX4 may include a first reset transistor RX1, a second reset transistor RX2, and an eleventh sub-capacitor C11. The fifth pixel PX5 may include a twenty-first sub-capacitor C21 and a twenty-second sub-capacitor C22. The sixth pixel PX6 may include a twenty-third sub-transistor C23 and a twelfth sub-capacitor C12. In an embodiment, the sum of the capacitances of the eleventh sub-capacitor C11 and the twelfth sub-capacitor C12 is equal to the capacitance of the first capacitor C1. In an embodiment, the sum of the capacitances of the twenty-first sub-capacitor C21 to the twenty-third sub-capacitor C23 is equal to the capacitance of the second capacitor C2.

To dispose more transistors in the same or similar area, the pair of active regions included in each of the first reset transistor RX1 to the third reset transistor RX3 and the selection transistor SX of the third pixel PX3 and the fourth pixel PX4 may extend in different directions from each other. The selection transistor SX may include a gate structure 1050, a first active region 2051 and a second active region 2052. The gate structure 1050, the first active region 2051 and the second active region 2052 are arranged in an L shape. The third reset transistor RX3 may include a gate structure 1051, a first active region 2053 and a second active region 2054. The gate structure 1051, the first active region 2053 and the second active region 2054 are arranged in an L shape. For example, in the selection transistor SX, the first active region 2051 may extend in the first direction (X direction), and the second active region 2052 may extend in the second direction (Y direction). For example, in the third reset transistor RX3, the first active region 2053 may extend in the first direction (X direction), and the second active region 2054 may extend in the second direction (Y direction). The first reset transistor RX1 may include a gate structure 2070, a first active region 2071 and a second active region 2072. The gate structure 2070, the first active region 2071 and the second active region 2072 are arranged in an L shape. The second reset transistor RX2 may include a gate structure 1071, a first active region 2073 and a second active region 2074. The gate structure 1071, the first active region 2073 and the second active region 2074 are arranged in an L shape For example, in the first reset transistor RX1, the first active region 2071 may extend in the first direction (X direction), and the second active region 2072 may extend in the second direction (Y direction). For example, in the second reset transistor RX2, the first active region 2073 may extend in the first direction (X direction), and the second active region 2074 may extend in the second direction (Y direction).

The first floating diffusion region FD may be electrically connected to the gate structure of the source-follower transistor SF and the active region of the first reset transistor RX1. The active region of the first reset transistor RX1 may be electrically connected to the active region of the second reset transistor RX2, and the active regions of the eleventh sub-capacitor C11 and the twelfth sub-capacitor C12. The active region of the second reset transistor RX2 may be electrically connected to the active regions of the twenty-first sub-capacitor C21 and the twenty-second sub-capacitor C22, the active region of the twenty-third sub-capacitor C23, and the active region of the third reset transistor RX3. The active region of the source-follower transistor SF may be electrically connected to the active region of the selection transistor SX.

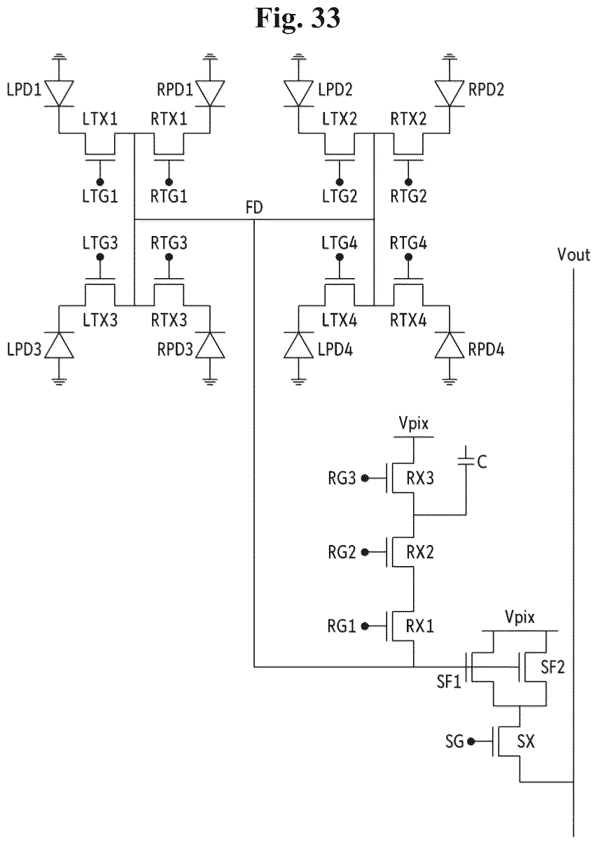

FIG. 33 is a circuit diagram showing a pixel of the image sensor according to an embodiment of the present invention.

Referring to FIG. 33, and FIG. 22, the pixel array 20 may include a pixel circuit that converts charges generated in each photodiode of a plurality of adjacent pixels into a voltage signal.

For example, the first pixel PX1 may include a first photodiode LPD1 and a second photodiode RPD1, and may include a first transfer transistor LTX1 that connects the first photodiode L PD1 and the floating diffusion region FD, and a second transfer transistor RTX1 that connects the second photodiode RPD1 and the floating diffusion region FD. The first transfer transistor LTX1 may be controlled by a first transfer control signal LTG1. The second transfer transistor RTX1 may be controlled by a first transfer control signal RTG1.

The second pixel PX2 includes a third photodiode LPD2 and a fourth photodiode RPD2, and may include a third transfer transistor LTX2 that connects the third photodiode LPD2 and the floating diffusion region FD, and a fourth transfer transistor RTX2 that connects the fourth photodiode RPD2 and the floating diffusion region FD. The third transfer transistor LTX2 may be controlled by a third transfer control signal LTG2. The fourth transfer transistor RTX2 may be controlled by a first transfer control signal RTG2.

The third pixel PX3 includes a fifth photodiode LPD3 and a sixth photodiode RPD3, and may include a fifth transfer transistor LTX3 that connects the fifth photodiode LPD3 and the floating diffusion region FD, and a sixth transfer transistor RTX3 that connects the sixth photodiode RPD3 and the floating diffusion region FD. The fifth transfer transistor LTX3 may be controlled by a fifth transfer control signal LTG3. The sixth transfer transistor RTX3 may be controlled by a sixth transfer control signal RTG3.

The fourth pixel PX4 includes a seventh photodiode LPD4 and an eighth photodiode RPD4, and may include a seventh transfer transistor LTX4 that connects the seventh photodiode LPD4 and the floating diffusion region FD, and an eighth transfer transistor RTX4 that connects the eighth photodiode RPD4 and the floating diffusion region FD. The seventh transfer transistor LTX4 may be controlled by a seventh transfer control signal LTG4. The eighth transfer transistor RTX4 may be controlled by an eighth transfer control signal RTG4.

The floating diffusion region FD may be connected to the gates of the source-follower transistors SF1 and SF2 that operate as an amplifier.

The input terminals of the first source-follower transistor SF1 and the second source-follower transistor SF2 are connected to a power supply node that supplies a power supply voltage Vpix. An output signal Vout may be output through the selection transistor SX. When the selection transistor SX is turned on by the selection control signal SG, the source-follower transistors SF1 and SF2 may amplify the voltage of the floating diffusion region FD to output the output signal Vout.

In an embodiment, the first reset transistor RX1, the second reset transistor RX2, and the third reset transistor RX3 are connected in series between the floating diffusion region FD and the power supply node. In an embodiment, the first reset transistor RX1 is directly connected to the floating diffusion region FD, and the third reset transistor RX2 is directly connected to the power supply node. In an embodiment, the second reset transistor RX2 is directly connected to the first reset transistor RX1 and the third reset transistor RX3. A capacitor C may be connected between the second reset transistor RX2 and the third reset transistor RX3.

The capacitance of the floating diffusion region FD may change depending on whether the first reset transistor RX1 and the second reset transistor RX2 are turned on or off. For example, when the first reset transistor RX1 and the second reset transistor RX2 are both turned off, the capacitance of the floating diffusion region FD may be determined as the sum of the capacitance of the active regions that provide the floating diffusion region FD in each of the first pixel PX1 and the second pixel PX2 and the capacitance of the wiring pattern that connects the active regions. Meanwhile, when the first reset transistor RX1 is turned on and the second reset transistor RX2 is turned off, the capacitance of the floating diffusion region FD may become larger by the capacitance of the first reset transistor RX1 than in a case where the first reset transistor RX1 and the second reset transistor RX2 are both turned off. Therefore, the conversion gain of the image sensor may be reduced. Also, when the first reset transistor RX1 and the second reset transistor RX2 are both turned on, the first reset transistor RX1 is turned on, the capacitance of the floating diffusion region FD may become larger by the sum of the capacitance of the second reset transistor RX2 and the capacitance of the capacitor C than in a case where the second reset transistor RX2 is turned off. Therefore, the conversion gain of the image sensor may be reduced.

As a result, in the image sensor according to an embodiment of the present invention, the conversion gain may be adjusted by controlling the turning-on/off of the first reset transistor RX1 and the second reset transistor RX2. When the number of reset transistors is N, the conversion gain of the image sensor may be set to one of N distinct values.

For example, in a low-illumination environment in which the amount of light flowing into the photodiodes PD1 and PD2 is small, both the first reset transistor RX1 and the second reset transistor RX2 may be turned off to increase the conversion gain of the image sensor. On the other hand, in a high-illumination environment in which the amount of light flowing into the photodiodes PD1 and PD2 is large, both the first reset transistor RX1 and the second reset transistor RX2 may be turned on to increase the capacitance of the floating diffusion region FD, thereby preventing saturation. The increase in the capacitance may decrease the conversion gain.

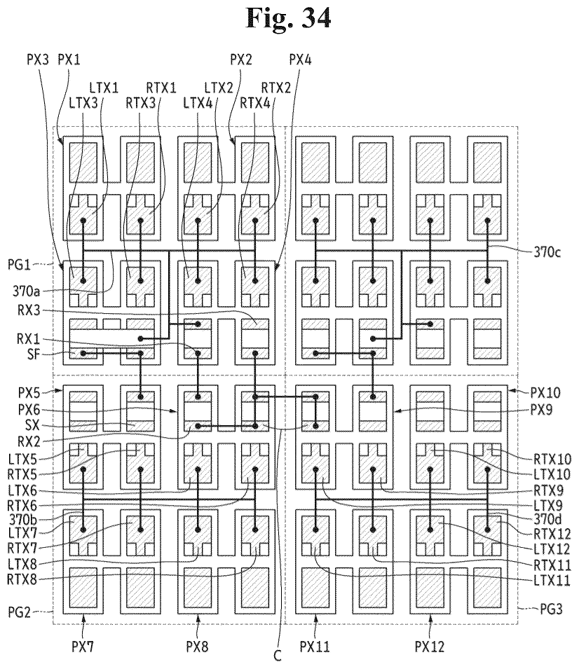

FIG. 34 is a diagram showing some pixels included in the image sensor according to an embodiment of the present invention.

Referring to FIGS. 33 and 34, the pixel circuit shown in FIG. 33 may be disposed on a substrate.

In some embodiments, the first pixel group PG1 includes a first pixel PX1 and a second pixel PX2 that are adjacent to each other in the first direction (X direction), and a third pixel PX3 and a fourth pixel PX4 that are adjacent to the first pixel PX1 and the second pixel PX2 in the second direction (Y direction). The second pixel group PG2 may include a fifth pixel PX5 and a sixth pixel PX6 that are adjacent to each other in the first direction (X direction), and a seventh pixel PX7 and an eighth pixel PX8 that are adjacent to the fifth pixel PX5 and the sixth pixel PX6 in the second direction (Y direction). The third pixel group PG3 may include a ninth pixel PX9 and a tenth pixel PX10 that are adjacent to each other in the first direction (X direction), and an eleventh pixel PX11 and a twelfth pixel PX12 that are adjacent to the ninth pixel PX9 and the tenth pixel PX10 in the second direction (Y direction). The fourth pixel group PG4 may include a thirteenth pixel PX13 and a fourteenth pixel PX14 that are adjacent to each other in the first direction (X direction), and a fifteenth pixel PX15 and a sixteenth pixel PX16 that are adjacent to the thirteenth pixel PX13 and the fourteenth pixel PX14 in the second direction (Y direction).

Each of the first pixel PX1 to the sixteenth pixel PX16 may include a first photodiode and a second photodiode that are adjacent to each other in the first direction (X direction).

The first transfer transistor LTX1 and the second transfer transistor RTX1 may be disposed in the first pixel PX1, and the third transfer transistor LTX2 and the fourth transfer transistor RTX2 may be disposed in the second pixel PX2. The fifth transfer transistor LTX3 and the sixth transfer transistor RTX3 may be disposed in the third pixel PX3. The seventh transfer transistor LTX4 and the eighth transfer transistor RTX4 may be disposed in the fourth pixel PX4. A ninth transfer transistor LTX5 and a tenth transfer transistor RTX5 may be disposed in the fifth pixel PX5, and an eleventh transfer transistor LTX6 and a twelfth transfer transistor RTX6 may be disposed in the sixth pixel PX6. A thirteenth transfer transistor LTX7 and a fourteenth transfer transistor RTX7 may be disposed in the seventh pixel PX7. A fifteenth transfer transistor LTX8 and a sixteenth transfer transistor RTX8 may be disposed in the eighth pixel PX8. A seventeenth transfer transistor LTX9 and an eighteenth transfer transistor RTX9 may be disposed in the ninth pixel PX9. A nineteenth transfer transistor LTX10 and a twentieth transfer transistor RTX10 may be disposed in the tenth pixel PX10. A twenty-first transfer transistor LTX11 and a twenty-second transfer transistor RTX11 may be disposed in the eleventh pixel PX11. A twenty-third transfer transistor LTX12 and a twenty-fourth transfer transistor RTX12 may be disposed in the twelfth pixel PX12.

The third pixel PX3 may include a source-follower transistor SF. The fourth pixel PX4 may include a first reset transistor RX1 and a third reset transistor RX3. The fifth pixel PX5 may include a selection transistor SX. In an embodiment, the capacitor C is disposed across a partial region of the sixth pixel PX6 and the eleventh pixel PX11.

In some embodiments, for example, the first transfer transistor LTX1 to the eighth transfer transistor RTX4 disposed in the first pixel group PG1 may be electrically connected to each other by the first wiring pattern 370a. Accordingly, the first floating diffusion region may be formed. Also, the ninth transfer transistor LT X 5 to the sixteenth transfer transistor RTX8 disposed in the second pixel group PG2 may be electrically connected to each other by the second wiring pattern 370b. As a result, the second floating diffusion region may be formed. A seventeenth transfer transistor LTX9 to a twenty-fourth transfer transistor RTX12 disposed in the third pixel group PG3 may be electrically connected to each other by a third wiring pattern 370d. Accordingly, the third floating diffusion region may be formed. The first floating diffusion region of FIG. 34 corresponds to the floating diffusion region FD of FIG. 33. Hereinafter, the term “first floating diffusion region” is changed to a “floating diffusion region,” and a connection relationship between the elements connected to the first floating diffusion region will be explained.

The floating diffusion region FD may be electrically connected to the gate structure of the source-follower transistor SF and the active region of the first reset transistor RX1. The active region of the first reset transistor RX1 may be electrically connected to the active region of the second reset transistor RX2. The active region of the second reset transistor RX2 may be electrically connected to the active region of the third reset transistor RX3 and the active region of the capacitor C. The active region of the source-follower transistor SF may be electrically connected to the active region of the selection transistor SX.

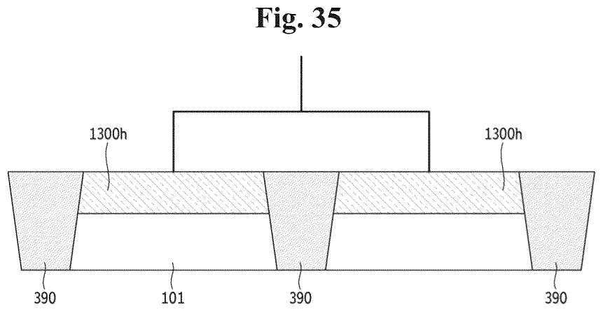

FIGS. 35 to 37 are cross-sectional views showing a shape of the capacitor included in the pixel of the image sensor according to an embodiment.

Referring to FIGS. 33 and 35, in some embodiments, the capacitor C does not include a gate structure, and a capacitance may be formed between an active region 1300h and a substrate 101. When the first reset transistor RX1 and the second reset transistor RX2 are turned on, the capacitor C is connected to the floating diffusion region FD, and the conversion gain of the image sensor may be reduced.

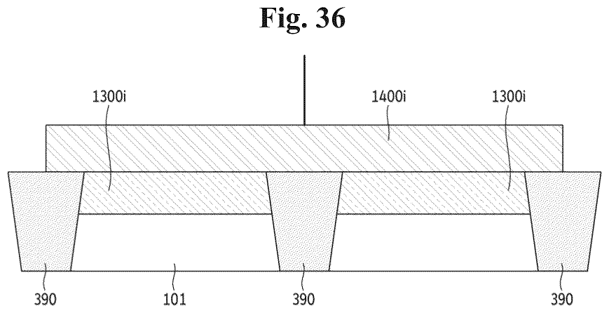

Referring to FIGS. 33 and 36, in some embodiments, the capacitor C may include a gate electrode 1400i on an upper end of an active region 1300i to minimize an area of the wiring pattern. When the first reset transistor RX1 and the second reset transistor RX2 are turned on, the conversion gain of the image sensor may be reduced by the capacitance formed between the active region 1300i and the substrate 101.

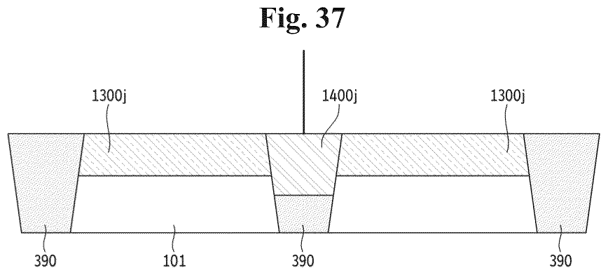

Referring to FIGS. 33 and 37, in some embodiments, the capacitor C may include a gate electrode 1400j on a part of the element separation layer 390 to minimize an area of the wiring pattern. When the first reset transistor RX1 and the second reset transistor RX2 are turned on, the conversion gain of the image sensor may be reduced by the capacitance formed between the active region 1300j and the substrate 101.

Although embodiments of the present invention have been described above with reference to the accompanying drawings, the present invention is not limited to the above embodiments, and may be implemented in various different forms. For example, the present invention may be embodied in other specific forms without changing the technical spirit or features of the present invention. Accordingly, the above-described embodiments should be understood in all respects as illustrative and not restrictive.

What is claimed is:

1. An image sensor comprising:
a substrate;
a first pixel group disposed on the substrate to include a first pixel and a second pixel disposed to adjacent to the second pixel in a first direction, a third pixel disposed adjacent to the first pixel in a second direction intersecting the first direction, and a fourth pixel disposed adjacent to the second pixel in the second direction;
a second pixel group disposed adjacent to the first pixel group in the second direction to include a fifth pixel disposed adjacent to the third pixel in the second direction, and a sixth pixel disposed adjacent to the fourth pixel in the second direction;
a first floating diffusion region electrically connected to the first to fourth pixels;
a second floating diffusion region electrically connected to the fifth and sixth pixels; and
a first reset transistor that connects a first capacitor to the first floating diffusion region based on a first control signal,
wherein each of the first to fourth pixels includes a first photoelectric conversion element, a first transfer transistor connected to the first photoelectric conversion element and the first floating diffusion region, a second photoelectric conversion element, and a second transfer transistor connected to the second photoelectric conversion element and the first floating diffusion region,
wherein each of the fifth pixel and the sixth pixel includes a third photoelectric conversion element, a third transfer transistor connected to the third photoelectric conversion element and the second floating diffusion region, a fourth photoelectric conversion element, and a fourth transfer transistor connected to the fourth photoelectric conversion element and the second floating diffusion region,
wherein the first capacitor and the first reset transistor are each disposed in any one of the third to sixth pixels.

2. The image sensor of claim 1,
wherein the first capacitor is disposed inside the sixth pixel, and the first reset transistor is disposed inside the fourth pixel.

3. The image sensor of claim 2, further comprises:
a first source-follower transistor and a second source-follower transistor disposed inside the third pixel;
a second reset transistor disposed inside the fourth pixel; and
a selection transistor disposed inside the fifth pixel,
wherein gates of the first and second source-follower transistors are electrically connected to the first floating diffusion region and an active region of the first reset transistor,
wherein the active region of the first reset transistor, the active region of the second reset transistor, and the active region of the first capacitor are electrically connected to one another, and
wherein the active regions of the first source-follower transistor and the second source-follower transistor are electrically connected to the active region of the selection transistor.

4. The image sensor of claim 2, further comprises:
a second capacitor disposed inside the sixth pixel;
a third capacitor disposed inside the fifth pixel;
a first source-follower transistor and a second source-follower transistor disposed inside the third pixel;
a second reset transistor is disposed inside the fourth pixel; and
a selection transistor is disposed inside the fifth pixel,
wherein gates of the first and second source-follower transistors are electrically connected to the first floating diffusion region and an active region of the first reset transistor,
wherein the active region of the first reset transistor, the active region of the second reset transistor, and the active regions of the first to third capacitors are electrically connected to one another, and
wherein the active regions of the first source-follower transistor and the second source-follower transistor are electrically connected to the active region of the selection transistor.

5. The image sensor of claim 2, further comprising:
a second capacitor disposed inside the sixth pixel;
a third capacitor and a fourth capacitor disposed inside the fifth pixel;
a first source-follower transistor and a selection transistor disposed inside the third pixel;
a second reset transistor disposed inside the fourth pixel,
wherein gates of the first and second source-follower transistors are electrically connected to the first floating diffusion region and an active region of the first reset transistor, and the active region of the first reset transistor, the active region of the second reset transistor, and the active regions of the first to fourth capacitors are electrically connected to one another, and
wherein the active region of the first source-follower transistor is electrically connected to the active region of the selection transistor.

6. The image sensor of claim 2, further comprising:
a second capacitor disposed inside the sixth pixel;
third and fourth capacitors disposed inside the fifth pixel;
a fifth capacitor disposed inside the fourth pixel;
a first source-follower transistor and a selection transistor disposed inside the third pixel; and
a second reset transistor disposed inside the fourth pixel,
wherein gates of the first and second source-follower transistors are electrically connected to the first floating diffusion region and an active region of the first reset transistor,
wherein the active region of the first reset transistor, the active region of the second reset transistor, and the active regions of the first to fifth capacitors are electrically connected to one another, and
wherein the active regions of the first source-follower transistor is electrically connected to the active region of the selection transistor.

7. An image sensor comprising:
a substrate;
a first pixel group disposed on the substrate to include a first pixel and a second pixel disposed adjacent to the first pixel in a first direction, a third pixel disposed adjacent to the first pixel in a second direction intersecting the first direction, and a fourth pixel disposed adjacent to the second pixel in the second direction;
a second pixel group disposed adjacent to the first pixel group in the second direction to include a fifth pixel disposed adjacent to the third pixel in the second direction, and a sixth pixel disposed adjacent to the fourth pixel in the second direction;
a first floating diffusion region electrically connected to the first to fourth pixels;
a second floating diffusion region electrically connected to the fifth and sixth pixels;
a first reset transistor that connects a first capacitor to the first floating diffusion region based a first control signal; and
a second reset transistor that connects a second capacitor, the first capacitor, and the first floating diffusion region based on a second control signal,
wherein each of the first to fourth pixels includes a first photoelectric conversion element, a first transfer transistor connected to the first photoelectric conversion element and the first floating diffusion region, a second photoelectric conversion element, and a second transfer transistor connected to the second photoelectric conversion element and the first floating diffusion region,
wherein each of the fifth pixel and the sixth pixel includes a third photoelectric conversion element, a third transfer transistor connected to the third photoelectric conversion element and the second floating diffusion region, a fourth photoelectric conversion element, and a fourth transfer transistor connected to the fourth photoelectric conversion element and the second floating diffusion region,
wherein the first capacitor, the second capacitor, the first reset transistor and the second reset transistor are each disposed in any one of the third to sixth pixels.

8. The image sensor of claim 7,
wherein the first capacitor is disposed inside the fifth pixel, the second capacitor is disposed inside the sixth pixel, the first reset transistor is disposed inside the fourth pixel, and the second reset transistor is disposed inside the sixth pixel.

9. The image sensor of claim 8, further comprising:
a first source-follower transistor and a second source-follower transistor disposed inside the third pixel;
a selection transistor disposed inside the fifth pixel;
a third reset transistor disposed inside the fourth pixel;
wherein gates of the first and second source-follower transistors are electrically connected to the first floating diffusion region and an active region of the first reset transistor,
wherein the active region of the first reset transistor, the active region of the second reset transistor, and the active region of the first capacitor are electrically connected to one another,
wherein the active region of the second reset transistor is electrically connected to the active region of the third reset transistor and the active region of the second capacitor,
wherein the active region of the third reset transistor is electrically connected to a power supply, and
wherein the active region of the first source-follower transistor is electrically connected to the active region of the selection transistor.

10. The image sensor of claim 7, further comprising a third capacitor,
the first capacitor is disposed inside the fourth pixel,
the second capacitor and the third capacitor are disposed inside the fifth pixel,
the first reset transistor is disposed inside the fourth pixel, and
the second reset transistor is disposed inside the sixth pixel.

11. The image sensor of claim 10, further comprising:
a first source-follower transistor and a selection transistor disposed inside the third pixel; and
a third reset transistor disposed inside the sixth pixel,
wherein gate of the first source-follower transistor is electrically connected to the first floating diffusion region and an active region of the first reset transistor,
wherein the active region of the first reset transistor, the active region of the second reset transistor, and the active region of the first capacitor are electrically connected to one another,
wherein the active region of the second reset transistor is electrically connected to the active region of the third reset transistor, the active region of the second capacitor, and the active region of the third capacitor,
wherein the active region of the third reset transistor is electrically connected to a power supply, and
wherein the active region of the first source-follower transistor is electrically connected to the active region of the selection transistor.

12. The image sensor of claim 7, further comprising third and fourth capacitors,
the first capacitor is disposed inside the fourth pixel,
the second capacitor is disposed inside the sixth pixel,
the third capacitor is disposed inside the fifth pixel,
the fourth capacitor is disposed inside the third pixel,
the first reset transistor is disposed inside the fourth pixel, and
the second reset transistor is disposed inside the sixth pixel.

13. The image sensor of claim 12, further comprising:
a first source-follower transistor disposed inside the third pixel; and
a selection transistor and a third reset transistor disposed inside the fifth pixel,
wherein gate of the first source-follower transistor is electrically connected to the first floating diffusion region and an active region of the first reset transistor,
wherein the active region of the first reset transistor and the active region of the second reset transistor, the active region of the first capacitor, and the active region of the second capacitor are electrically connected to one another,
wherein the active region of the second reset transistor is electrically connected to the active region of the third reset transistor, the active region of the third capacitor, and the active region of the fourth capacitor,
wherein the active region of the reset transistor is electrically connected to a power supply, and
wherein the active region of the first source-follower transistor is electrically connected to the active region of the selection transistor.

14. The image sensor of claim 13,
wherein each of the selection transistor and the third reset transistor includes a first sub-active region and a second sub-active region,
the first sub-active region extends in the first direction, and
the second sub-active region extends in the second direction intersecting the first direction.

15. The image sensor of claim 7, further comprising a third capacitor to a fifth capacitor,
the first capacitor is disposed inside the fourth pixel,
the second capacitor is disposed inside the sixth pixel,
the third capacitor and the fourth capacitor are disposed inside the fifth pixel,
the fifth capacitor is disposed inside the sixth pixel, and
the first reset transistor and the second reset transistor are disposed inside the fourth pixel.

16. The image sensor of claim 15, further comprising:
a first source-follower transistor, a selection transistor, and a third reset transistor disposed inside the third pixel,
wherein gates of the first source-follower transistor and the selection transistor are electrically connected to the first floating diffusion region and an active region of the first reset transistor,
wherein the active region of the first reset transistor, the active region of the second reset transistors, the active region of the first capacitor, and the active region of the second capacitor are electrically connected to one another,
wherein the active region of the second reset transistor is electrically connected to the active region of the third reset transistor and the active region of the third capacitor to the active region of the fifth capacitor,
wherein the active region of the third reset transistor is electrically connected to a power supply, and
wherein the active region of the first source-follower transistor is electrically connected to the active region of the selection transistor.

17. The image sensor of claim 16,
wherein the selection transistor and the first reset transistor to the third reset transistor each include a first sub-active region and a second sub-active region,
the first sub-active region extends in the first direction, and
the second sub-active region extends in the second direction intersecting the first direction.

18. The image sensor of claim 7, further comprising:
an internal pixel separation film disposed on the substrate, disposed between the first photoelectric conversion element and the second photoelectric conversion element included in the first pixel to the fourth pixel, and disposed between the third photoelectric conversion element and the fourth photoelectric conversion element included in the fifth pixel and the sixth pixel; and
a microlens disposed on the substrate,
wherein the internal pixel separation film includes a frontside deep trench isolation (FDTI) structure, and
the microlens is disposed below each of the first pixel to the sixth pixel.

19. An image sensor comprising:
a substrate;
first and second floating diffusion regions disposed in the substrate,
a first pixel including first and second photoelectric conversion elements, a first transfer transistor that connects the first photoelectric conversion element and the first floating diffusion region, and a second transfer transistor that connects the second photoelectric conversion element and the first floating diffusion region;
a second pixel including third and fourth photoelectric conversion elements, a third transfer transistor that connects the third photoelectric conversion element and the first floating diffusion region, and a fourth transfer transistor that connects the fourth photoelectric conversion element and the first floating diffusion region;
a third pixel including fifth and sixth photoelectric conversion element, a fifth transfer transistor that connects the fifth photoelectric conversion element and the first floating diffusion region, and a sixth transfer transistor that connects the sixth photoelectric conversion element and the first floating diffusion region;
a fourth pixel including seventh and eighth photoelectric conversion elements, a seventh transfer transistor that connects the seventh photoelectric conversion element and the first floating diffusion region, and an eighth transfer transistor that connects the photoelectric conversion element and the first floating diffusion region;
a fifth pixel including ninth and tenth photoelectric conversion elements, a ninth transfer transistor that connects the ninth photoelectric conversion element and the second floating diffusion region, and a tenth transfer transistor that connects the tenth photoelectric conversion element and the second floating diffusion region; and
a sixth pixel including eleventh and twelfth photoelectric conversion elements, an eleventh transfer transistor that connects the eleventh photoelectric conversion element and the second floating diffusion region, and a twelfth transfer transistor that connects the twelfth photoelectric conversion element and the second floating diffusion region,
wherein at least one of the third to sixth pixels includes
a first and a second capacitor,
a first reset transistor that connects the first capacitor and the first floating diffusion region based on a first control signal, and
a second reset transistor that connects the second capacitor, the first capacitor and the first floating diffusion region based on a second control signal.

20. The image sensor of claim 19,
wherein a capacitance of the second capacitor is greater than a capacitance of the first capacitor.
